(19) United States
(12) Patent Application Publication
(10) Pub. No.: US 2003/0237093 A1
(43) Pub. Date: Dec. 25, 2003

(54) Electronic program guide systems and methods for handling multiple users

(76) Inventor: David J. Marsh, Sammamish, WA (US)

Correspondence Address: LEE & HAYES PLLC, 421 W RIVERSIDE AVENUE SUITE 500, SPOKANE, WA, 99201

(21) Appl. No.: 10/174,634

(22) Filed: Jun. 19, 2002

(51) Int. Cl. H04N 5/445; G06F 3/00; G06F 13/00

(52) U.S. Cl. 725/46; 725/47

(57) ABSTRACT

Various methods and systems can facilitate handing multiple users in the context of electronic program guide systems. Various described embodiments permit the users to be identified to or registered with the system. The system can then establish a ranking or pecking order for the users. The ranking provides a point of reference from which the system can provide services to the users. Various methods and systems can ascertain the particular mix of users or viewers at any one time, and can then provide one or more services as a function of the viewers who are present. Additionally, some embodiments can ascertain when the collection of users has changed and can then offer a modified mix of services that are tailored to the new user collection. Further, some embodiments make use of the concept of personas for individual users. Individual users can have multiple different personas each of which being associated with a different set of preferences for that user. The system can then make recommendations and provide other services for the user based on their current persona.

### RELATED APPLICATIONS

This application is related to the following U.S. patent applications, the disclosures of which are incorporated by reference herein:

Application Ser. No. 10/125,260, filed Apr. 16, 2002, entitled “Media Content Descriptions” and naming Dave Marsh as inventor;

Application Ser. No. 10/125,259, filed Apr. 16, 2002, entitled “Describing Media Content in Terms of Degrees” and naming Dave Marsh as inventor;

Application Ser. No. ______, bearing Attorney Docket No. ms1-1088, filed May 11, 2002, entitled “Scoring And Recommending Media Content Based On User Preferences”, and naming Dave Marsh as inventor;

Application Ser. No. ______, bearing Attorney Docket No. ms1-1175, filed May 31, 2002, entitled “Entering Programming Preferences While Browsing An Electronic Programming Guide”, and naming Dave Marsh as inventor; and

Application Ser. No. ______, bearing Attorney Docket No. ms1-1186, filed Jun. 6, 2002, entitled “Methods and Systems for Generating Electronic Program Guides”, and naming Dave Marsh as inventor.

Application Ser. No. ______, bearing Attorney Docket No. ms1-1204, filed ______, entitled “Methods and Systems for Enhancing Electronic Program Guides”, and naming Dave Marsh as inventor.

Application Ser. No. ______, bearing Attorney Docket No. ms1-1187, filed ______, entitled “Electronic Program Guides Utilizing Demographic Stereotypes”, and naming Dave Marsh as inventor.

### TECHNICAL FIELD

This invention relates to media entertainment systems and, in particular, to systems and methods that are directed to personalizing a user's experience.

### BACKGROUND

Many media entertainment systems provide electronic programming guides (EPGS) that allow users to interactively select programs that they are interested in. Systems that employ EPG technology typically display programs organized according to the channel on which the program will be broadcast and the time at which the broadcast will occur. Information identifying a particular program typically includes the program title, and possibly a short description of the program. In today's world, media entertainment systems can typically offer hundreds of channels from which a user can choose. In the future, many more channels will undoubtedly be offered. This alone can present a daunting task for the user who wishes to locate particular programs of interest. Further complicating the user's experience is the fact that many current electronic programming guides (EPGs) can provide an abundance of information that can take several hours for a user to look through.

Against this backdrop, what many viewers typically end up doing is that they simply review a few favorite channels to see when their favorite programs are playing, and then view those programs at the appropriate times. Additionally, other viewers may simply revert to channel surfing. Needless to say, these outcomes do not provide the user with the best user experience or make effective and efficient use of the user's time.

Additionally, the present state of EPG technology does not address with any satisfaction issues associated with handling multiple users who may happen to be viewing programs at the same time.

Accordingly, this invention arose out of concerns associated with providing improved systems and methods that can provide media entertainment users with a rich, user-specific experience.

### SUMMARY

Various methods and systems can facilitate handing multiple users in the context of viewing systems such as electronic program guide systems. Various described embodiments permit the users to be identified to or registered with the system. The system can then establish a ranking or pecking order for the users. The ranking provides a point of reference from which the system can provide services to the users. Various methods and systems can ascertain the particular mix of users or viewers at any one time, and can then provide one or more services as a function of the viewers who are present. Additionally, some embodiments can ascertain when the collection of users has changed and can then offer a modified mix of services that are tailored to the new user collection. Further, some embodiments make use of the concept of personas for individual users. Individual users can have multiple different personas each of which being associated with a different set of preferences for that user. The system can then make recommendations and provide other services for the user based on their current persona.

### BRIEF DESCRIPTION OF THE DRAWINGS

FIG. 1 is a block diagram that illustrates program data in accordance with one or more embodiments.

FIG. 2 is a block diagram that illustrates an exemplary environment in which methods, systems, and data structures in accordance with the described embodiments may be implemented.

FIG. 3 is a block diagram that illustrates exemplary components of a content folder in accordance with one embodiment.

FIG. 4 is a flow diagram describing steps in a method in accordance with one embodiment.

FIG. 5 is a high level block diagram that illustrates aspects of but one system that can be utilized to implement one or more embodiments.

FIG. 6 is a block diagram that illustrates exemplary components of a client device in accordance with one embodiment.

FIG. 7 is a block diagram that illustrates a recommendation engine in accordance with one embodiment.

FIG. 8 is a flow diagram describing steps in a method in accordance with one embodiment.

FIG. 9 is a flow diagram describing steps in a method in accordance with one embodiment.

FIG. 10 is a flow diagram describing steps in a method in accordance with one embodiment.

FIG. 11 illustrates an exemplary indicator mechanism in accordance with one embodiment.

FIG. 12 is a block diagram that illustrates an exemplary system that can be used to implement one or more of the embodiments.

### DETAILED DESCRIPTION

Overview

Various methods and systems can facilitate handing multiple users in the context of viewing systems such as electronic program guide systems. Various described embodiments permit the users to be identified to or registered with the system. The system can then establish a ranking or pecking order for the users. The ranking provides a point of reference from which the system can provide services to the users. Various methods and systems can ascertain the particular mix of users or viewers at any one time, and can then provide one or more services as a function of the viewers who are present. Additionally, some embodiments can ascertain when the collection of users has changed and can then offer a modified mix of services that are tailored to the new user collection. Further, some embodiments make use of the concept of personas for individual users. Individual users can have multiple different personas each of which being associated with a different set of preferences for that user. The system can then make recommendations and provide other services for the user based on their current persona.

The discussion below begins with a description of an exemplary system and approach that can be utilized to implement the embodiments that are described further on in this document. It is to be appreciated that the embodiments described herein can be implemented in connection with any suitable EPG system. Hence, the claimed subject matter should not be limited to only those systems that are the same as, or similar to those described below.

Content Description Metadata Collection

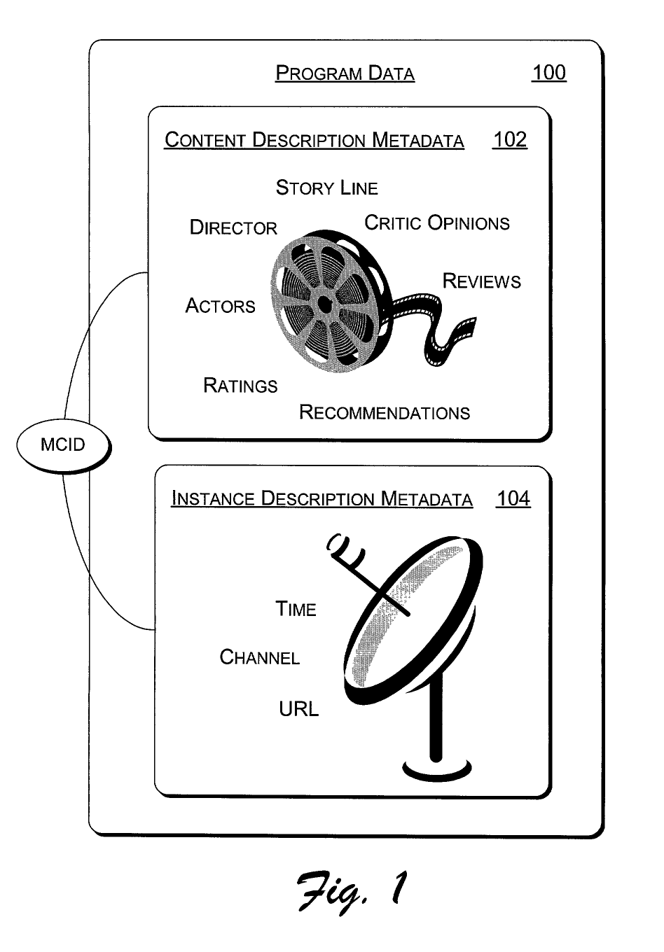

FIG. 1 illustrates two categories of program data 100 that can be associated with various media content (such as movies, television shows and the like) in accordance with the described embodiments. The two types of program data comprise content description metadata 102 and instance description metadata 104.

Content description metadata 102 can comprise a vast number of different types of metadata that pertain to the particular media content. The different types of content description metadata can include, without limitation, the director or producer of the content, actors in a program or movie, story line, ratings, critic opinions, reviews, recommendations, and the like.

Instance description metadata 104 comprises data that pertains to when and where the media content is available. For example, instance description metadata can include the day, time and television channel on which a particular movie or television program will be broadcast. Because content description metadata 102 is associated with the media content itself, and not when a particular instance of the media content is to be broadcast, the content description metadata can be maintained and updated throughout the life of a particular piece of media content.

In accordance with the described embodiments, the content description metadata and the instance description metadata are linked via a media content identifier number 106 or “MCID”. An MCID is a unique number that is assigned to the piece of media content to identify it. The MCID can provide a basis by which the particular media content can be easily and readily identified. Once identified, metadata associated with the media content can be easily updated and extended. MCIDs can also be used to generate electronic programming guides for the users and can provide the basis by which a user's likes and dislikes are measured against media content for purposes of recommending to the user those programs that the user would most like to view.

Exemplary Environment

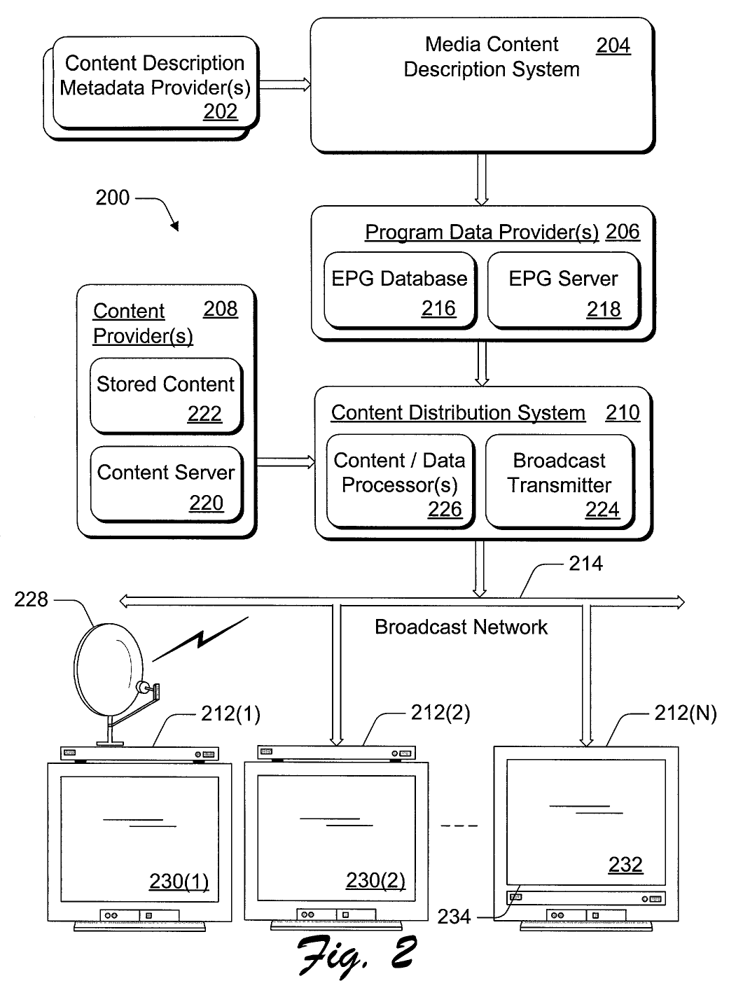

FIG. 2 illustrates an exemplary environment 200 in which the methods, systems, and data structures described herein may be implemented. The environment is a media entertainment system that facilitates distribution of media content and metadata associated with the media content to multiple users. Environment 200 includes one or more content description metadata providers 202, a media content description system 204, one or more program data providers 206, one or more content providers 208, a content distribution system 210, and multiple client devices 212(1), 212(2), . . . , 212(N) coupled to the content distribution system 210 via a broadcast network 214.

Content description metadata provider 202 provides content description metadata associated with media content to media content description system 204. Example content description metadata providers can include, without limitation, movie production companies, movie distribution companies, movie critics, television production companies, program distributors, music production companies, and the like. Essentially, any person, company, system, or entity that is able to generate or supply media content description metadata can be considered a content description metadata provider 202.

Media content description system 204 stores media content description metadata associated with a plurality of metadata categories and stores metadata received from one or more metadata providers 202. In one implementation, the media content description system 204 generates composite metadata based on metadata received from a plurality of metadata providers 202. Media content description system 204 provides the media content description metadata to program data provider 206. Typically, such metadata is associated with many different pieces of media content (e.g., movies or television programs).

Program data provider 206 can include an electronic program guide (EPG) database 216 and an EPG server 218. The EPG database 216 stores electronic files of program data which can be used to generate an electronic program guide (or, “program guide”). The program data stored by the EPG database, also termed “EPG data”, can include content description metadata 102 and instance description metadata 104. For example, the EPG database 216 can store program titles, ratings, characters, descriptions, actor names, station identifiers, channel identifiers, schedule information, and the like.

The EPG server 218 processes the EPG data prior to distribution to generate a published version of the EPG data which contains programming information for all channels for one or more days. The processing may involve any number of techniques to reduce, modify, or enhance the EPG data. Such processes can include selection of content, content compression, format modification, and the like. The EPG server 218 controls distribution of the published version of the EPG data from program data provider 206 to the content distribution system 210 using, for example, a file transfer protocol (FTP) over a TCP/IP network (e.g., Internet, UNIX, etc.). Any suitable protocols or techniques can be used to distribute the EPG data.

Content provider 208 includes a content server 220 and stored content 222, such as movies, television programs, commercials, music, and similar media content. Content server 220 controls distribution of the stored content 222 from content provider 208 to the content distribution system 210. Additionally, content server 220 controls distribution of live media content (e.g., content that is not previously stored, such as live feeds) and/or media content stored at other locations.

Content distribution system 210 contains a broadcast transmitter 224 and one or more content and program data processors 226. Broadcast transmitter 224 broadcasts signals, such as cable television signals, across broadcast network 214. Broadcast network 214 can include a cable television network, RF, microwave, satellite, and/or data network, such as the Internet, and may also include wired or wireless media using any broadcast format or broadcast protocol. Additionally, broadcast network 214 can be any type of network, using any type of network topology and any network communication protocol, and can be represented or otherwise implemented as a combination of two or more networks.

Content and program data processor 226 processes the media content and EPG data received from content provider 208 and program data provider 206 prior to transmitting the media content and EPG data across broadcast network 214. A particular content processor may encode, or otherwise process, the received content into a format that is understood by the multiple client devices 212(1), 212(2), . . . , 212(N) coupled to broadcast network 214. Although FIG. 2 shows a single program data provider 206, a single content provider 208, and a single content distribution system 210, environment 200 can include any number of program data providers and content providers coupled to any number of content distribution systems.

Content distribution system 210 is representative of a head end service that provides EPG data, as well as media content, to multiple subscribers. Each content distribution system 210 may receive a slightly different version of the EPG data that takes into account different programming preferences and lineups. The EPG server 218 creates different versions of EPG data (e.g., different versions of a program guide) that include those channels of relevance to respective head end services. Content distribution system 210 transmits the EPG data to the multiple client devices 212(1), 212(2), . . . , 212(N). In one implementation, for example, distribution system 210 utilizes a carousel file system to repeatedly broadcast the EPG data over an out-of-band channel to the client devices 212.

Client devices 212 can be implemented in multiple ways. For example, client device 212(1) receives broadcast content from a satellite-based transmitter via a satellite dish 228. Client device 212(1) is also referred to as a set-top box or a satellite receiving device. Client device 212(1) is coupled to a television 230(1) for presenting the content received by the client device, such as audio data and video data, as well as a graphical user interface. A particular client device 212 can be coupled to any number of televisions 230 and/or similar devices that can be implemented to display or otherwise render content. Similarly, any number of client devices 212 can be coupled to a television 230.

Client device 212(2) is also coupled to receive broadcast content from broadcast network 214 and communicate the received content to associated television 230(2). Client device 212(N) is an example of a combination television 232 and integrated set-top box 234. In this example, the various components and functionality of the set-top box are incorporated into the television, rather than using two separate devices. The set-top box incorporated into the television may receive broadcast signals via a satellite dish (similar to satellite dish 228) and/or via broadcast network 214. A personal computer may also be a client device 212 capable of receiving and rendering EPG data and/or media content. In alternate implementations, client devices 212 may receive broadcast signals via the Internet or any other broadcast medium.

Each client 212 runs an electronic program guide (EPG) application that utilizes the EPG data. An EPG application enables a TV viewer to navigate through an onscreen program guide and locate television shows of interest to the viewer. With an EPG application, the TV viewer can look at schedules of current and future programming, set reminders for upcoming programs, and/or enter instructions to record one or more television shows.

Content Folders

In accordance with the embodiments described below, the notion of a content folder is employed and utilized to hold metadata that pertains to media content that can be experienced by a user. The content folder can be utilized to hold or otherwise aggregate many different types of metadata that can be associated with the media content—including the media content itself. The metadata that is provided into a content folder can come from many different metadata providers and can be provided at any time during the life of the media content.

As an example, consider the following. When media content is first created, content description metadata can be provided for the particular media content. Such content description metadata can include such things as the name of the content (such as movie or program name), actors appearing in the movie or program, year of creation, director or producer name, story line description, content rating and the like.

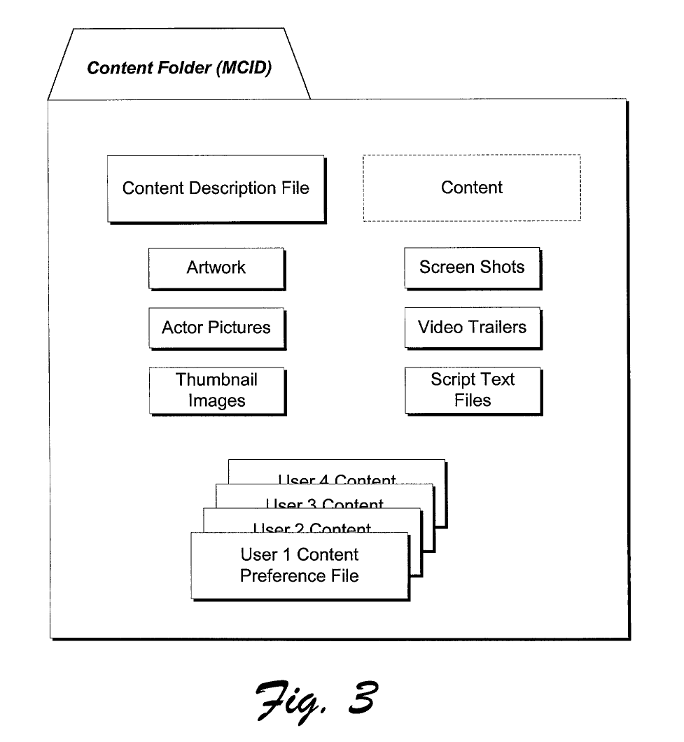

As an example, consider FIG. 3 which shows an exemplary content folder. The content folder is associated with a particular piece of content and, hence, is associated with an MCID that identifies the content. Within the content folder, many different types of metadata can be collected. For example, the content folder can include, without limitation, a content description file that describes the content (an example of which is provided below), and files associated with any artwork that might be associated with the content, actor pictures, thumbnail images, screen shots, video trailers, and script text files, to name just a few. The content folder can also contain the actual content itself, such as a digitally encoded program or movie. The content folder can, in some embodiments, contain one or more user content preference files which are described in more detail in the section entitled “User Content Preference File” below.

Over time, more content description metadata may become available and can be added to the content folder. For example, after a movie is released, critic opinions and recommendations may become available. Because this is information related to the media content itself (and not just a particular broadcast or showing of the media content), this information can be added to the content folder. At a still later point in time, additional reviews of the media content may become available and can thus be added to the content folder. Additional metadata that can be incorporated into the content folder can include such things as special promotional data associated with the content, data from fan sites, and many more different types of metadata.

Content description metadata can typically be generated by many different sources (e.g., movie production companies, movie critics, television production companies, individual viewers, etc.). A media content description system (such as system 204 in FIG. 2) can store content description metadata from the multiple sources, and can make the content description metadata available to users via one or more servers or other content distribution systems.

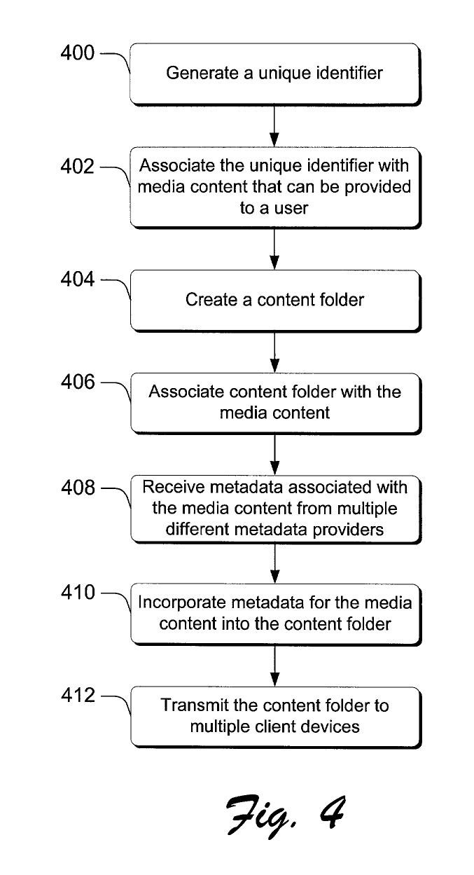

FIG. 4 is a flow diagram that describes steps in a metadata collection method in accordance with one embodiment. The steps can be implemented in any suitable hardware, software, firmware or combination thereof. In the illustrated example, the steps can be implemented in connection with a metadata collection and transmission system. Exemplary components that can perform the functions about to be described are shown and described in connection with FIG. 2.

Step 400 generates a unique identifier and step 402 associates the unique identifier with media content that can be provided to a user. An example of such a unique identifier is described above in connection with the MCID. The media content with which the unique identifier can be associated is a specific piece of media content, such as a specific movie or television program. In practice, these steps are implemented by one or more servers or other entities in connection with a vast amount of media content. The servers or entities serve as a collection point for metadata that is to be associated with the particular media content. Step 404 creates a content folder and step 406 associates the content folder with the particular media content. These steps can also be performed by the server(s) or entities. The intent of these steps is to establish a content folder for each particular piece of media content of interest.

Step 408 receives metadata associated with the media content from multiple different metadata providers. These metadata providers need not and typically are not associated or affiliated with one another. Step 410 then incorporates the metadata that is received from the various metadata providers into the content folder that is associated with the particular media content. As noted above, this process is an ongoing process that can extend during the entire life of the particular piece of media content. The result of this step is that, over time, a very rich and robust collection of metadata is built up for each piece of media content of interest. Software executing on the server can use aggregation techniques to ascertain the best value for each program attribute using the entries from the different metadata providers. For example, different opinions as to the value of attributes can be collected from the different metadata providers. The “best” value, i.e. the one that gets sent to the client, is built by the server software using various techniques depending on the attribute type. For example, sometimes the best value is the value from the most trustworthy metadata provider. Yet other times, a vote can be taken as to the best value. Still further, for example in the case of “Degrees Of” attributes, percentages can be calculated by looking at all of the opinions from the metadata providers. Data aggregation techniques are described in some of the applications incorporated by reference above. An example of a content folder is shown and described in FIG. 3.

Step 412 transmits the content folder to multiple different client devices. This step can be implemented by transmitting all of the constituent files of the content folder, or by transmitting a pared down version of the content folder—depending on the needs and capabilities of the particular client devices to which transmission occurs.

The content folders can be used in different ways. For example, the content folder can be used in an EPG scenario to enable the EPG software on the client device to generate and render an EPG for the user. The content folder can also be used by end users to hold not only the metadata for the media content, but the media content as well.

Using Content Folders to Generate EPGs

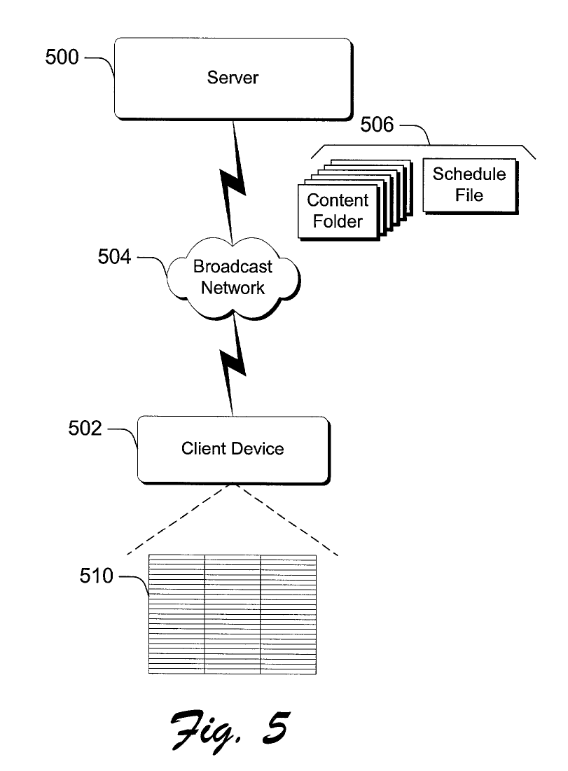

FIG. 5 is a block diagram that can be used to understand how the client device can use the various content folders to generate an EPG. In this example, a server 500 builds and maintains many different content folders, such as the content folders that are described above. In addition, the server can build a schedule file. The content folders and schedule files are shown collectively at 506.

The schedule file is a description of the programs that are to be broadcast over a future time period for which an EPG is going to be constructed. For example, the schedule file can describe which programs are going to be broadcast for the next two weeks. Thus, the schedule file contains the instance description metadata as described in FIG. 1. The schedule file can be implemented as any suitable type of file. In this particular example, the schedule file is implemented as an XML file. The schedule file refers to the pieces of media content (i.e. programs) by way of their respective unique identifiers or MCIDs. Thus, the schedule file contains a list of MCIDs, the times when, and the channels on which the associated programs are going to be broadcast.

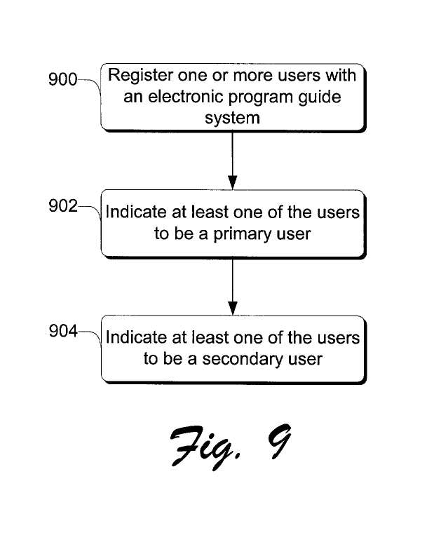

The schedule file and content folders that correspond to the MCIDs in the schedule file are transmitted, via a suitable broadcast network 504, to multiple client devices such as client device 502. The client device can now use the schedule file and the various content folders to construct an EPG grid, such as EPG 510, for the user. A specific example of an EPG such as one that can be generated in accordance with the embodiments described herein is shown in FIG. 9.

Specifically, when the client device receives the schedule file, an EPG application executing on the client device can read the schedule file and ascertain the MCIDs that correspond to the programs that are going to be broadcast. The EPG application can then construct a suitable grid having individual cells that are to contain representations of the programs that are going to be broadcast. Each cell typically corresponds to a different MCID. To populate the grid, the EPG application can access the appropriate the content folders, by virtue of the MCIDs that are associated with the content folders, and render the metadata contained in the content folder in the appropriate cell for the MCID of interest. The EPG application can also provide any user interface (UI) components that are desirable to access additional metadata that is not necessarily displayed—such as a movie trailer, a hyperlink and the like.

In one embodiment, an optimization can be employed to ensure that client devices are provided metadata within the content folder that they can use. Thus, metadata that is not necessarily useful for the client device can be excluded from the content folder that is transmitted to the client device. For example, if the client device does not have a position in its user interface to display a particular piece of information, or if the client device lacks the necessary resources to meaningfully use the metadata (e.g. the client lacks the capabilities to display a video trailer), then such metadata should not be transmitted to the client device when the content folders are transmitted. One way of implementing such an optimization is as follows. Prior to downloading the content folders, server 500 and client device 502 communicate with one another by, for example, a SOAP protocol, and the client device identifies for the server which information or metadata it is interested in. This can assist the server in assigning a class designation to the client device (e.g. thick client, thin client and/or varying degrees therebetween) so that the appropriate metadata is sent to the client.

The content folders can be used by the client device in a couple of different ways depending on the configuration and capabilities of the client device. For clients that are “thick” and support a database querying engine (such as a SQL engine), complex querying can be utilized locally on the client. In this case, certain files (such as the content description file) within the content folder can be read into the client's database and requests for program information can be sent from the EPG application to the database engine for execution. Support files such as the artwork and trailer files are not loaded into the database, but rather are read by the EPG application directly from the content folders. For clients that do not support a database engine, metadata can be read directly from the files.

Using Content Folders to Organize Metadata and Media Content

Content folders can also be used to contain not only the pertinent metadata, but the associated media content as well. This use can occur on either the server or the client side. Typically, however, this use will occur with more frequency on the client side.

Recall from FIG. 5 and the discussion above, that the client devices typically receive multiple different content folders that are individually associated with specific media content that has yet to be broadcast. Thus, as noted in FIG. 3, the client devices will typically have a number of these content folder without the associated content. When the content is acquired by the client, as by being broadcast or downloaded (for example in a Personal Video recorder application), the content itself can be added to the content folder so that individual content folders now contain not only pertinent metadata, but the corresponding content as well. Typically, such content can be digitally encoded into an appropriate file (such as an MPEG 2 file) and added to the content folder.

This can be advantageous from the standpoint of being able to abstract a specific piece of media content into an entity (i.e. the content folder) that represents not only the content itself, but a potentially rich user experience made possible by the inclusion of the various types of metadata with the content. Having an abstracted entity that contains not only the content, but the associated metadata as well can be employed in the context of peer-to-peer exchanges. For example, if a user wishes to provide a piece of content to a friend, then they can simply send them the abstracted entity that includes not only the content, but all of the supporting metadata files as well.

Exemplary Client Architecture

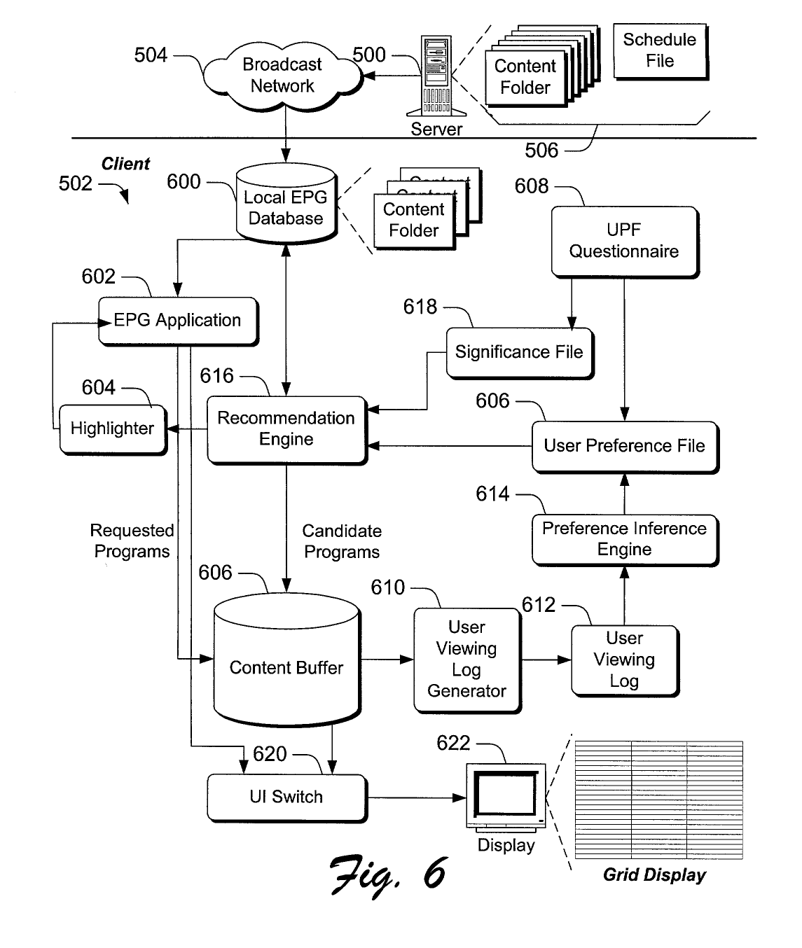

FIG. 6 is a block diagram that illustrates exemplary components of a client system or device 502 in accordance with one embodiment, and expands upon the client device shown and described in FIG. 5. Client system 502 can operate as a user preference recommendation system that can score programs that are available for viewing according to a user's preferences, and recommend certain programs that meet particular conditions that are specific to a particular user.

Client system 502 can include a local electronic programming guide (EPG) database 600 that stores content folders that can include content files, support files and content description files associated with the content files that are downloaded from a server. An exemplary content description file is described in the section entitled “Content Description File” below. Database 600 can also store the schedule file. The database can comprise a traditional database such as that which would reside on a thick client. Alternately, for thin clients, the database would typically be less extensive than for thick clients.

The EPG database 600 provides data to an electronic programming guide (EPG) application 602. The EPG application 602 is configured to enable displays of program names, dates, times, lengths, etc. in a grid-like user interface. A highlighter component 604 can highlight particular programs displayed on an EPG grid. The particular programs that can be highlighted by the highlighter component 604 can be a function of a user's likes and dislikes. Client 502 also includes a content buffer 606 that can store content folders and media content associated with particular content folders. For example, the content buffer can be utilized to store programs that are designated by the user for recording so that the user can later view the program. This will become more apparent in connection with the discussion that appears in the section entitled “Recommendation Lists” below.

The client 502 also includes one or more user preference files (UPF) 606 associated with a user or users of the client. The client 502 can contain more than one user preference file for each user.

The user preference file can be utilized to store values for various attributes of media content (such as television programs). Each attribute value can have a preference value associated with it that indicates how much the particular user likes or dislikes that particular attribute value in a program. Advantageously, the user preference file and the content description file can conform to a common content description schema which can facilitate matching up various programs with the user's preferences. The user preference file 606 can advantageously allow for the separation of the process of establishing user preferences, from the process of matching the user preferences with programs that are available for viewing.

Various techniques can be utilized to populate user preference file 606 with useful information about the user, such as what attribute values of television programs are liked and disliked by the user.

One way to generate a user preference file is to provide the user with a UPF questionnaire 608 that queries the user directly about which attribute values are important to the user. After the user preference file is initially constructed, it can be periodically updated with new information about preferred program attribute values. The user may, for example, simply recall the UPF questionnaire 608 and add additional information or edit information that is already in the file.

Another way to generate a user preference file makes use of a user viewing log generator 610 that monitors programs that are watched by the user or listed by the user for consumption. Program attribute values associated with the monitored programs, together with the time that the program was viewed are logged in a user viewing log 612. At predetermined intervals, a preference inference engine 614 can build up the user preference file using information contained in the user viewing log 612. User preference files are described in more detail in the section entitled “User Preference File” below.

Client 502 also includes a recommendation or matching engine 616 that drives the comparison of a particular user preference file with content description files associated with programs that are available for viewing.

When recommendation engine 616 determines that an attribute value in the user preference file matches an attribute value found in a content description file, the matching engine 616 can calculate an attribute score for the matching attribute. For example, an “actor” attribute in the user preference file may contain a value of “Steve Martin.” If an “actor” attribute in the content description file also contains the value of “Steve Martin,” then the “actor” attribute is designated as a matching attribute. An attribute score can then be assigned to the matching attribute, and one or more attribute scores assigned in a program can be used to calculate a program score for the program.

In one embodiment, recommendation engine 616 can make use of a significance file 618 when calculating the scores of a particular program. The significance file can contain significance values that are utilized in the calculation of program scores. Significance files are described in more detail below in the section entitled “Significance Files”.

The output of recommendation engine 616 are various score-based recommendations that can be provided on a user-by-user basis. Various nuances of scoring characteristics and techniques are described below in more detail.

Client 502 can also comprise a user interface (UI) switch 620 and a display 622 such as a television or monitor on which an EPG grid can be rendered. Although the display is shown as being a part of client 502, it is to be appreciated and understood that the display can be separate from the client, such as in the case where the client is embodied in a set top box (STB). The UI switch 620 is effectively used to switch between stored programs in the content buffer 606 and live programs emanating from a content source.

Content Description Schema

As noted above, to facilitate matching attribute values that the user likes (as indicated in their user preference file) with the attribute values of the content programs (as indicated in the content description files) a comprehensive and consistent description schema is used to describe the content.

But one example of an exemplary content description schema that includes metadata categories that correspond to content attributes is described in U.S. patent application Ser. No. 10/125,260, incorporated by reference above.

User Preference File

The user preference file (UPF) is a global file that describes program attributes that the user likes. There is typically one user preference file per user, although users can have more than one user preference file for such things as representing multiple different user personas. In addition to describing the user's likes and dislikes in terms of program attributes, the user preference file can contain other global system attributes that relate to a particular user such as, for example, user interface setup options and programs the user always wishes to have recorded.

Against each program attribute is a preference number that can have a positive value (to indicate a level of desirability associated with content having that attribute), or a negative value (to indicate a level of undesirability associated with content having that attribute). In the example described below, preference numbers can range from −5 to +5.

The user preference file can be implemented in any suitable file format. In the example described below, the user preference file is implemented as an XML file and uses the same schema as the content description files (described in the section entitled “Content Description File” below) that are used to describe the attributes of the content.

A representation of an exemplary content description schema as employed in the context of a user preference file appears directly below. This representation contains only an abbreviated selection of attributes and attribute values. Accordingly, a typical user preference file can contain more entries than those shown, and/or different attributes and/or attribute values.

<Person Entries>

<PersonName=“Julia Roberts” PersonRole=“Actor” Xpref=“−3”/>
<PersonChar=“Miss Marple” Xpref=“+1”/>
<PersonName=“Ron Howard” PersonRole=“Director” Xpref=“+5”/>

...
<Person Entries>
<Title Entries>

<TitleName=“Friday 13” Xpref=“+3”/>
<TitleName=“The Jerk” Xpref=“+5”/>

...
<Title Entries>
...

### Example User Preference File Schema

The user preference file is defined in terms of the same metadata attributes or categories that are used to describe the content in the content description files. The user preference file, however, adds one or more additional attributes that are specific to its associated user. A separate but compatible schema could be used for both the user preference file and the content description file. However, as a content description schema is an evolving concept that can add additional metadata categories over time, it is more desirable, for purposes of synchronization, to have the schemas remain synchronized. Thus, it is desirable to use the same schema for both the content description file and the user preference file.

The excerpt of the user preference file above includes tags that encapsulate various attributes and their associated values. In this specific example, “Person Entries” tags encapsulate attributes and values associated with particular individuals or characters. “Title Entries” tags encapsulates attributes and values associated with particular titles.

The “Person Entries” tag encapsulates a “Person Name” attribute that is used to identify a person such as an actor who is preferred by a particular user. A Person Name attribute value contains a character string such as an actor's name, e.g. “Julia Roberts.” This indicates that the user corresponding to the particular user preference file has a preference—either a like or a dislike—for Julia Roberts in a particular context.

The “Person Entries” tag also encapsulates a “Person Role” attribute that identifies a particular function or context of the person identified in the “Person Name” attribute. This can allow a user to distinguish between actors who may also be directors in some programs. For example, the user may like movies in which Clint Eastwood stars, but may dislike movies in which Clint Eastwood directs. In this particular example, the “Person Role” attribute for Julia Roberts indicates that this entry pertains to Julia Roberts in the context of an actor, and not in some other context.

A preference attribute “Xpref=” is also provided for the “Person Name” and “Person Role” attributes and enables the user to enter a value or preference rating that indicates how much, relatively, the user likes or dislikes the value specified in the “Person Name” attribute for the context defined by the “Person Role” attribute. In this particular example, the user has indicated a value of “−3” for Julia Roberts in the context of an actor.

The “Person Entries” tag also encapsulates a “Person Character” attribute and value, as well as a preference attribute and rating associated with that “Person Character” attribute. The “Person Character” attribute enables a user to identify particular characters that the user likes or dislikes. In the present example, the Person Character attribute value comprises “Miss Marple”, and the preference rating associated with that character is “+1”. This indicates that the user slightly prefers programs in which this character appears.

There can be virtually any number of similar entries encapsulated by the “Person Entries” tag. For example, another “Person Name” attribute is defined for Ron Howard in the context of director and contains a preference rating of “+5”, which indicates a strong preference for programs directed by Ron Howard.

Similarly, the “Title Entries” tags encapsulate “Title Name” attributes and associated values, as well as associated preference attributes and their associated ratings. In this example, a first “Title Name” attribute equals “Friday 13” having an associated preference attribute with a rating of “+2”. A second “Title Name” attribute equals “The Jerk” having an associated preference attribute with a rating of “+5”.

Whether attribute values actually match or not, and the extent to which attribute values match with attributes in the content description files depends on the particular entry type. For example, entry types can be used when exact matches are desired. This might be the case where a user has a particular preference for movie sound tracks in the French language. Yet other entry types can be used when an exact match is not necessarily needed or desired. Such might be the case, for example, when a user is interested in any of the movies in the “Friday the 13^{th}” series of movies. In this case, a match can be deemed to have occurred if the term “Friday 13” appears anywhere in the title of a movie.

Content Description File

Recall that each content folder, such as the one shown and described in FIG. 3, contains a content description file. In the present embodiment, the content description file uses the same schema as does the user preference file. The content of the files, however, can be different. An exemplary portion of a content description file is provided below. The content description file can contain more entries or attributes than those shown below. For example, attributes can include a title attribute, a content identifier attribute, a date of release attribute, a running time attribute, a language attribute, and the like.

<Person Entries>

<PersonName=“Russell Crowe” PersonRole=“Actor”/>
<PersonChar=“John Nash”/>

<Person Entries>
<Title Entries>

<TitleName=“A Beautiful Mind”/>

<Title Entries>

### Example Content Description File Schema

Accordingly, the “Person Entries” tag includes a “Person Name” attribute and value that are used to identify individuals associated with the content. In this particular case, the attribute can be used to designate actors appearing in a particular program. The “Person Entries” tag also includes a “Person Role” attribute and value that identifies a particular function or context of the person identified in the “Person Name” attribute. In this particular example, the “Person Name” and “Person Role” attributes for the content indicates that Russell Crowe is associated with the program in the context of an actor.

The “Person Entries” tag also encapsulates a “Person Character” attribute and value. The “Person Character” attribute identifies particular characters that appear in the program or movie. In the present example, the Person Character attribute value comprises “John Nash”.

Similarly, the “Title Entries” tags encapsulate a “Title Name” attribute and associated value which designates the title of the content. In this example, the “Title Name” attribute equals “A Beautiful Mind”.

As noted above, the user preference file and the content description file contain many of the same attributes. This is due to the fact that the files utilize the same content description schema to describe content attributes. This greatly facilitates the process of matching program attributes with a user's preferred attributes.

User Content Preference File

Various embodiments can also make use of user content preference files. A user content preference file is different from a user preference file. Recall that a user preference file is a global file that describes attributes that a user likes and dislikes. A user content preference file, on the other hand, is not a global file. Rather, the user content preference file is associated with each particular piece of content for each user or user preference file. The user content preference files are maintained in the content folder and describe how well a particular piece of content matches up with an associated user preference file. So, for example, if there are four users who use the particular client device, then there should be four User Preference Files that describe each user's likes and dislikes. For each content folder in the client system, then, there should be four User Content Preference files—one for each user describing how well this particular content matches up with the user's likes and dislikes.

User Content Preference files can facilitate the processing that is undertaken by the recommendation engine. Specifically, because of the large number of content folders, user preference files and the like, a recommendation engine can take a long time to execute. In practice, the recommendation engine is executed as a batch process. The results of the recommendation engine can be stored in the user content preference file so that they can be accessed by whatever application may need them.

In addition to indicating how well the particular content matches up with a user's user preference file, the user content preference file can include additional user-specific data that is particular to that piece of content. For example, if the user is a film buff and always wants to ensure that these particular movies are shown in a particular aspect ratio or using Dolby surround sound, such information can be located in the User Content Preference file.

The User Content Preference files can be used to generate human-readable reports that describe how the recommendation engine arrived at a particular score. This can be a desirable feature for more sophisticated users that can assist them in adjusting, for example, their program attribute preferences to refine the recommendations produced by the recommendation engine.

Significance File

Some program attribute matches that are found by the recommendation engine can be more important or significant than others. Significance values, as embodied in a significance file such as significance file 618 in FIG. 6, provide a way for the system to appropriately weight those things that are truly significant to a particular user.

A significance file is a global file that is used to store significance values that correspond to each attribute available in a program. Each significance value denotes a relative importance of the attribute with which it corresponds as compared to the other attributes. Use of significance values provides an appropriate weighting factor when determining whether a program should be recommended to a user or not. That is, when a recommendation engine compares a user's preference file with a content description file and finds a match between particular attribute values, the recommendation engine can multiply the preference rating for the matching attribute in the user's preference file with the corresponding significance value for that attribute in the significance. The product of this operation can then contribute to the overall score of a particular program for purposes of determining whether a recommendation should be made or not.

In accordance with one embodiment, the significance file uses the same schema as the content description file (so that everything stays in synch), and extends the schema by including an additional attribute (“XSignif”) that enables the user to express the significance of a particular attribute of the content description file. As an example, consider the excerpted portion of a significance file that appears directly below.

<Person Entries>

<PersonName=“ ” XSignif=“63”/>
<PersonChar=“ ” XSignif=“87”/>

<Person Entries>
<Title Entries>

<TitleName=“ ” XSignif=“99”/>

<Title Entries>

### Example Significance File Schema

The above significance file excerpt includes a “Person Entries” tag and a “Title Entries” tag. These tags encapsulate many of the same attributes that appear in the user preference file and content description file.

Specifically a “Person Name” attribute is encapsulated by the “Person Entries” tag. Associated with the “Person Name” attribute is a significance attribute “XSignif” that is used to define the relative importance of a person associated with a particular piece of content as compared with other attributes. In this example, a significance value of “63” is assigned to the “Person Name” attribute. Assuming for purposes of this example that significance values range from zero to one hundred, a value of “63” indicates that a match of this attribute is generally important to the user.

A “Person Character” attribute is also encapsulated by the “Person Entries” tag, and the corresponding significance attribute “XSignif” of “87” indicates that a match of this attribute is more important to the calculation of the program score than a match of the “Person Name” attribute.

A “Title Name” attribute is encapsulated by the “Title Entries” tag and, in this example, an associated significance attribute “XSignif” of “99” indicates that a match of this attribute is even more important than a match of the “Person Character” attribute.

It should be noted that the significance values could be stored in the user preference files along with each entry therein, thereby making the significance values user specific rather than system wide. They could even be associated with the particular preferences, however, doing so would require redundant entries since some attributes may be repeated with different attribute values. For example, a user preference file may include fifty actors' names that a user prefers to see. If the significance values were to be included in the user preference file associated with particular preferences, then each of the fifty entries for actors' names would have to include the same significance value. Thus, by virtue of the fact that the significance file is a global file, such redundancies can be avoided.

Additionally, it should be appreciated that it is not necessary for the user to create and/or have control over the significance file. Rather, another entity such as a content provider may assign the significance values for a particular client system. While such an implementation would not provide as close a fit with each user's personal preferences, it would relieve the user from having to individually do the work.

As an example of how a client device or system can employ a significance file and significance values, consider the following. Assume that in a user's preference file the user includes the same rating or preference value (e.g. +5) for the “Title Name” and “Person Character” attributes. For example, perhaps the “Title Name” of concern is the “Seinfeld” show and the “Person Character” of interest is the Kramer character. Thus, in this instance, the user really likes the Seinfeld show and the Kramer character. Notice in the excerpted portion of the significance file that appears above, the “Title Name” attribute has a significance value of “99”, while the “Person Character” attribute has a significance value of “87”. Thus, although the user may enter the same preference value for the Title Name attribute value and the Person Character attribute value (i.e. +5) because the user strongly prefers both, all other things being equal, by using the significance file the system would determine that this user prefers a Seinfeld episode that features the Kramer character (with a corresponding score of 5*87+5*99=930) over a Seinfeld episode that does not feature the Kramer character (with a corresponding score of 5*99=495).

For many of the program attribute types, the significance file can have multiple numbers, each tagged with the type of match to which they relate. The most commonly used tags can be “Full” and “Part” which refer respectively to a full match or just a partial match. Finding a keyword within a plot abstract is an example of a partial match.

Running the Recommendation Engine

Typically, the recommendation engine is run or otherwise executed for every piece of content for every user on the client system. Needless to say, this can involve a fairly large amount of processing for the client system. Various strategies can be used on the client to effectively hide this processing time. This can be particularly important in the context of client devices that do not employ high end processors.

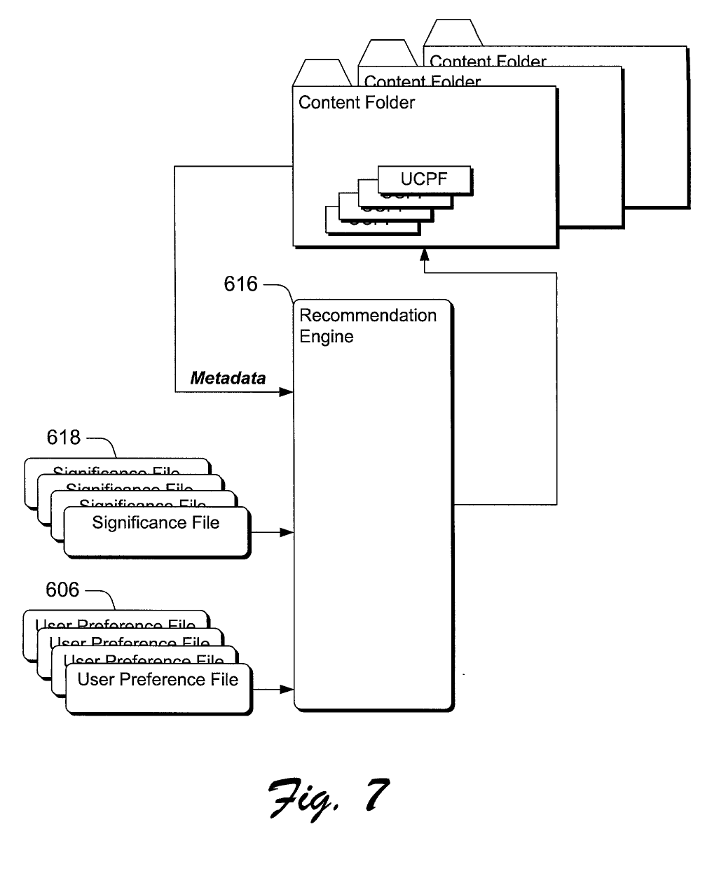

As an example, consider FIG. 7 which illustrates, in somewhat more detail, the processing that can take place at the recommendation engine 616. Typically, there are a number of different inputs to the recommendation engine. Here, the inputs can include the metadata from each of the content folders, the input from each user's associated significance file 618, and the input from each user's preference file 606. For each piece of content that the client receives (i.e. for each content folder), the recommendation engine is run with these inputs. The recommendation engine 616 processes inputs and then provides an output that includes, among other things, the scores for the various programs, for each user, that are slated for broadcasting during the next period of time. This data can be provided by the recommendation engine into user content preference files (UCP files) that are contained in each of the content folders. Additionally, the recommendation engine's output is also used to make recommendations for the various users via the EPG that is generated and displayed for the users. Those programs that more closely match a particular user's likes can be displayed more prominently than those program that do not closely match a user's likes.

In accordance with one embodiment, recommendation engine 616 can be run or executed as the content description information (i.e. the content folders) are downloaded from the server. Downloading of the content folders can be scheduled such that the content folders are downloaded at a time when the users are not likely to be using the client system, e.g. very early in the morning. Typically, content folders that are downloaded are associated with content that is to be broadcast up to a couple of weeks into the future. Downloads can be scheduled for once a day such that if for some reason a download does not happen on a particular day, the next day's download can catch up. In practice, it is usually sufficient for downloads to occur at least once a week so that the user's experience is not disrupted. Accordingly, scheduling downloads for every day can provide plenty of room to account for such things as bandwidth limitations and the like.

Thus, typically, the recommendation engine can be scheduled to run every night. In some situations, it can be desirable to immediately run the recommendation engine if, for example, something in the client system changes that would make running the recommendation engine desirable. For example, assume that a user is watching a particular program and something or someone in the program catches their eye. Perhaps they notice a new actor whom they really like. The user may opt to update their user preference file to reflect that they would like to have more recommendations made for any programs in which this particular actor appears. Here, then, it can be desirable to immediately run the recommendation engine to incorporate the user's new changes in their user preference file. This can provide the user with immediate feedback and recommendations. In practice, however, this may be unnecessary because the user's change may not necessarily change the overall scores very much.

Sorting the Scores

During the download of content description data (i.e. content folders), recommendation engine 616 calculates a score for each program. At the end of the complete process, the recommendation engine can sort the scores for all of the programs so that it is later able to display a sorted list of recommendations to the user. This list of sorted scores can be kept in a separate scores file. The scores file can include a list of the MCIDs for each of the programs and the corresponding score for each MCID. Each user can have a separate scores file that contains their own scores for the various programs. Using only an MCID is sufficient in this case because with the MCID, all other relevant information pertaining to a particular program can be accessed.

The scores file can be stored as part of the user preference file, or in an accompanying file that is associated with the user. The latter would go far to ensure that the user preference file does not become too bloated.

Privacy Issues

Because the user preference files and scores files contain sensitive information, various protections can be utilized to ensure that the user preference files and, if a separate file—the scores files—are protected.

To protect the user preference and scores files, the files can be encrypted and access to the files can be via password. Any suitable encryption techniques can be utilized such as DES or AES security techniques. Other methods of protection can be utilized such as storing the files on a removable smartcard.

Relative Scoring

As noted above, each program that is to be broadcast in a forthcoming schedule is given a score by the recommendation engine. The actual score that each program receives is not as important as the score's significance relative to all of the other scores. That is, it is more useful to assess the scores of each program relative to the scores for the other programs. Thus, it can be advantageous to translate each program's actual score into a relative score so that its importance to the individual users can be ascertained relative to the other programs that are to be broadcast.

In accordance with one embodiment, the recommendation engine computes a score for each of the programs that are to be broadcast. The recommendation engine then takes this score and computes a relative score that provides a measure of how one particular program relates all of the other programs that are to be broadcast. One way of computing a relative score is to divide each program's individual score by the highest score found for any program in the forthcoming schedule. To facilitate this calculation, the recommendation engine can, at the conclusion of the download and metadata matching processes, determine the highest score and save this score in a global location, e.g. in a particular user's user preference file. As further individual scores are computed for each of the programs for each of the users, each program's relative score can be computed as well.

It can be advantageous to translate each program's relative score into a useful visual display that can be readily utilized by a user for selecting programs. For example, a star rating system can be utilized. One way of implementing a star rating system can be as follows. Programs that receive a negative score (and hence are not desirable from a user's standpoint) will not receive a recommendation star. Similarly, programs that receive scores that are less than typically about half of the highest score will not receive a recommendation star. Various thresholds can be used to ascertain how many stars a program is to receive. It can be desirable for the thresholds associated with the different star ratings to be user programmable so that individual users can define how stars are to be assigned. As an example, consider the following exemplary threshold settings and associated stars:

| 0-50% (and negative scores) | No star |
|---|---|
| 50-60% | One star |
| 60-70% | Two stars |
| 70-80% | Three stars |
| 80-90% | Four stars |
| 90-100% | Five stars |

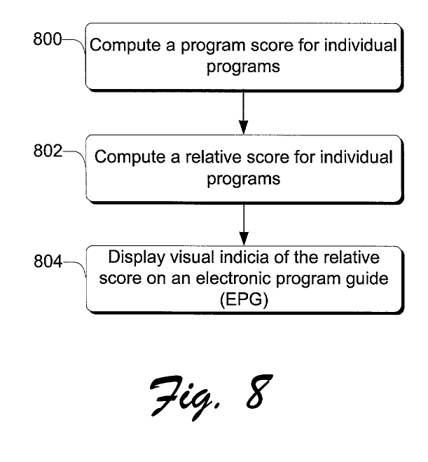

FIG. 8 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 800 computes a program score for individual programs that are to be represented in an electronic program guide. Program scores can be computed in any suitable way. One way of computing program scores is described in this document and the others that have been incorporated by reference above. In those systems, computation of the program scores is performed by a recommendation engine that can compute scores as a function of metadata that describes media content and preferences that have been expressed by users in terms of a user preference file. Step 802 computes, from the program score for each program, a relative score for that program. The relative score provides a measure of how well a particular program relates to the other programs that are to be broadcast. One way of computing a relative score is described just above. Step 804 then displays visual indicia of the relative score on an EPG. This step can be implemented by rendering an EPG and providing, within or associated with individual cells of the EPG, the visual indicia for an associated program. Any suitable visual indicia can be utilized. For example, the visual indicia can comprise a number that reflects the relative score, one or more symbols (such as a star or a number of stars), or a color that is associated with or used to accent individual cells (e.g. green cells indicate highly recommended programs, yellow cells indicate program of moderate or little interest, and red cells indicate programs that are not recommended).

Handling Multiple Users

In some of the embodiments described above, a user's preferences can be taken into account by a process that can recommend programs to the user that may be of particular interest to them. Thus, a very personalized user experience can be provided to individual users. The process of recommending programs to a particular user can be extended to include a scenario where multiple users constitute a viewing audience. In this scenario, it is desirable for the electronic program guide system to ascertain who the particular users are at any one time. In accordance with one embodiment, the concept of primary and secondary users is introduced. Having primary and secondary users can facilitate the recommendation process when there are multiple users or viewers in the viewing audience. That is, if the system is able to ascertain, from a group of users, a particular user who is the “primary” user, then the system can have a point of reference from which it can make various decisions such as which user preference file or files to use, which rules to implement, which services to offer, and the like. Additionally, while the present embodiment is discussed in the context of an EPG and program recommendation system, it is to be appreciated and understood that the principles described herein can pertain to all program watching experiences and all one-to-many viewing and interaction environments.

For example, each family member in a household typically likes different programs. The kids may like Nickelodeon, the mother may like gardening and cookery programs, and the father may like horror movies and football. By identifying the particular users that make up the viewing audience, the EPG system can take steps to ensure that accurate recommendations are made for the users that constitute the viewing audience. Moreover, it is also advantageous for parental guidance and privacy reasons to provide security mechanisms that pertain to how users are identified by the system, as will become apparent below.

The methods and systems described below provide various approaches that address the multiple user scenario. The various approaches constitute relatively unobtrusive approaches insofar as user convenience is concerned. Various user identification methods are described that can be utilized to identify users that constitute a viewing audience.

There are a number of reasons why it can be important to ascertain who the particular users are at any one time. For example, because user preferences (as described above in the context of user preference files) are such a personal thing, a failure to accurately identify users can potentially translate into poor program recommendations. That is, if while the system is learning what the user likes and dislikes, the system does not accurately know who the particular user is, then incorrect program attributes can get added to various user preference files, thus resulting in incorrect program recommendations. It can also be important to ascertain the composition of a group of users for purposes of recommending desirable types of programs. For example, the types of programs that the system recommends might be different when Dad is watching television with his kids, as compared with what it recommends when he is watching television without the kids around. Specifically, Dad may highly prefer sports programs, particularly when they concern professional basketball and baseball. The kids, however, may not prefer sports at all and would rather enjoy adventure movies and cartoons. Thus, when dad is viewing television with his kids, it can be more desirable in this example to produce a mix of recommendations which take into account both Dad's and the kids' preferences. Another reason why it can be important for the system to know who is watching is so that the system can remember when each user last watched each program. This can become important when it comes to only recommending programs to users that they have not recently watched.

The issue of user identification can have a much greater significance than simply providing good program recommendations. User identification can be advantageous for purposes of providing security. For example, young children need to be protected from being exposed to unsuitable adult content. Thus, it is desirable for an EPG system that handles multiple users to take into account the desire of parents to protect their children from inappropriate content. For example, the system should be at a minimum very difficult for children to fool into thinking that an adult watching.

Note that even in the case where there are no parental control issues to be concerned about, it is still desirable to have some kind of secure authentication mechanism. This can prevent, for example, kids from corrupting their father's user preferences by selecting user “Dad” and then watching cartoons all day. Further, having a degree of security in the multiple user context can go a long way to protecting a user's privacy. For example, Dad may not want Mom to know the types of programs he watched when she was out. Because User Preference Files build up a large amount of information that may be sensitive, it can become important to protect this information from being viewed by others.

One way to address all of these concerns is to provide a mechanism by which users can securely log into the EPG system. Having a secure log in process coupled with the concept of primary and secondary users can provide a very powerful tool that can greatly enhance a user's experience while addressing many if not all of the issues mentioned above.

Establishing a Pecking Order

In accordance with one embodiment, the system establishes a ranking of the users that typically use the system. The highest ranking person in the room at any one time becomes the Primary user and lesser ranked people become the secondary users. If the highest ranked person at any one time leaves the room then the next highest ranked person remaining becomes the Primary user.

In a typical family unit, it is possible to define a pecking order or ranking for the registered users of the system. In many households, a default ranking might comprise Dad at the top, then Mom, and then the children according to their ages, followed by any visitors the family may have.

Once a pecking order or ranking has been established, the system need only ascertain who is in the room in order to ascertain the primary user. The user in the room with the highest pecking order or ranking can be designated as the primary user. Using the example pecking order mentioned above, if Dad is in the room, he is the primary user. If Dad is not in the room and Mom is in the room, then Mom is the primary user. If Mom is not in the room, then the eldest child in the room is the primary user and so on.

It can also be advantageous to have an adjustable pecking order or ranking such that it can be adjusted by the owner or administrator of the system. Thus, for example, Dad might determine that the secondary users, other than Mom, having the highest grade point average will get to be at the top of the rankings for the children. Conceivably, this ranking could change from report card to report card.

In the above-described embodiment, the primary and the secondary users can be determined from two separate pieces of information: the pecking order established at system setup time or some later time, and knowledge of who is in the room or viewing area. Because the pecking order is a static piece of information, in practice the problem becomes just one of determining who is in the room. Additionally, because of the security issues mentioned above, it can also be advantageous to accurately know who is in the room.

In accordance with the embodiments described below, systems and methods provide a secure way of indicating that a user has entered the program viewing area. Additionally, the systems and methods can provide a verifiable way of indicating those users the system thinks are present. Further, the systems and methods can provide a way of specifying that a particular user has left the viewing area.

The system can be initially configured with the names of the different users when the system is set up. For example, when the system is installed and operation begins, a system administrator, such as Dad, can enter names for all of the family users. This also establishes a User Preference File for each user. During initialization, the users can also provide any information that is needed or desirable for authentication and secure login, e.g. thumbprints and the like.

For some users it may not be desirable to specify the requirement for a secure login. This may be the case with small children. Accordingly, another user such as Dad or Mom can be given the permission to indicate that those users are present. It can also be desirable to allow a user, such as a system administrator, to have administrative privileges to specify that any other particular user is present.

FIG. 9 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 900 registers one or more users with an electronic program guide system. This step can be implemented when the EPG system is initially configured. Alternately or additionally, the step can be implemented at some later time, such as when the system is updated to either add or remove users. Step 902 indicates at least one of the users to be a primary user. In the illustrated and described embodiments, having a primary user provides a point of reference for the EPG system so that it can make decisions and take actions in accordance with any rules that are defined for it. Step 904 indicates at least one of the other users to be a secondary user. This also establishes a point of reference for the EPG system. Collectively, steps 902 and 904 define a pecking order or ranking of the EPG system users. Various purposes for the pecking order will become evident below.

User Switching

Having primary and secondary users allows for user collections to be defined. Each user collection can comprise one or more users and can potentially have a different set of rules that govern program viewing and recommendation. One of the advantages of knowing who and who is not in the viewing area is that when one or more users arrive or leave to effectively change the user collection, the set of rules that govern the new user collection may change as well. This can have an effect on the program recommendations, the program currently being viewed and the like. For example, if Dad is the primary user and he is in the viewing area with two of his kids, when Dad leaves the viewing area the primary user can change to one of the kids. If this is the case, programs that might have been recommended for the group of “Dad+kids” may not be appropriate for the group of “kids”. This aspect is discussed in more detail in the section entitled “System Behavior with Multiple Users” below.

Changes that occur to the EPG system as a result of one or more of the primary and secondary users changing need not, however, take place immediately. That is, when the primary user or the secondary users change, it is not necessary to make any immediate change to what is being displayed on the TV screen. The new user collection may not need to be used until the next time that a user action is initiated with respect to the EPG system. Such user actions can include engaging the remote control to change the channel, accessing the electronic program guide or recommendation engine to select another program, saving user preferences, or any other action that changes the currently displayed video. This can avoid disrupting program viewing until there is a natural disruption initiated by a user action.

There may be instances, however, when it is desirable to immediately effect a change via the EPG system as a result of the user collection changing. As an example, consider the case where a user with a high parental guidance rating, such as Dad, wishes to stop others, such as the kids, from enjoying those privileges when Dad leaves the room. It can be convenient in these circumstances to provide a mechanism to immediately initiate an update. Such a mechanism might be a physical mechanism such as a button that can be located on a login panel associated with the EPG system. Alternately, such mechanism might be a rule that is defined that effectively indicates that when Dad is the primary user and he is with the kids, if Dad leaves the viewing area, the new rules associated with the new user collection immediately go into effect. The effect of this rule can be to immediately change the program if the program is one that is not suitable for the user collection of “kids only.” That is, if the current program contains content that is compatible with a reduced parental control setting, then the program will not be changed when Dad leaves the room (as indicated by either Dad invoking a physical mechanism such as a button, or Dad's departure being automatically detected). If, on the other hand, the current program is not compatible with a reduced parental control setting, then the EPG system can either automatically change the program to a more suitable one, or the system can present a selection screen to allow the remaining users to select a program that is compatible with their parental rating.

Identifying Users in the Viewing Area

As noted above, it can be advantageous to ascertain the composition of the present group of users of the EPG system. Once the composition of the user group is known, the EPG system can provide services to that particular group of users both as a function of the group, and as individual users. For example, some of the services that can be provided include, without limitation, program recommendation, user preference file updates, program presentation, implementation of parental monitoring, and the like.

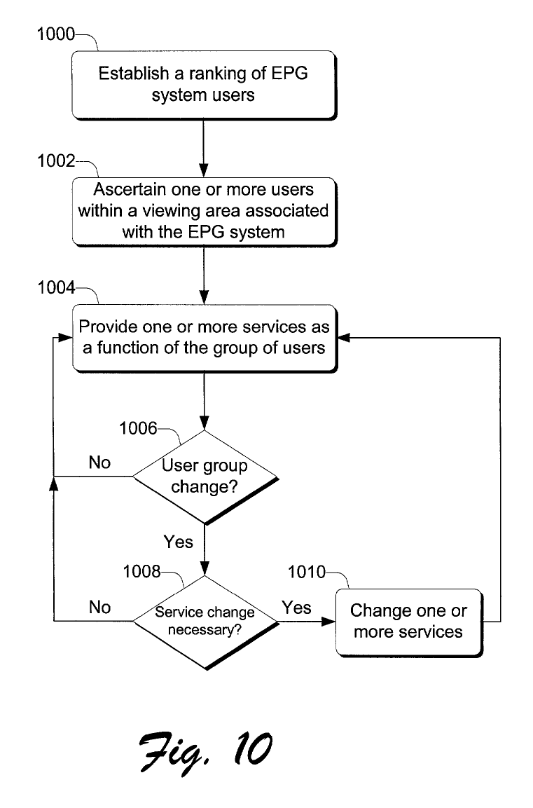

FIG. 10 is a flow diagram that describes steps in a method for providing EPG system services, in accordance with one embodiment. The method can be implemented in any suitable hardware, software, firmware or combination thereof. In the illustrated example, the method can be implemented in connection with an EPG system such as the one discussed above.

Step 1000 establishes a ranking of the EPG system users. Any suitable method can be employed to establish the user rankings, examples of which are given above. Moreover, any suitable ranking system can be employed. Step 1002 ascertains one or more users within a viewing area associated with the EPG system. Any suitable method can be used to ascertain or otherwise identify the users within the viewing area of the EPG system. Specific examples of systems that can be used are given below.

Step 1004 provides one or more services as a function of the group of users. Any suitable type of service can be provided. Examples of different types of services that can be provided by the EPG system are given above. Step 1006 determines whether the user group changes. A user group can change by one or more users leaving the viewing area or arriving into the viewing area. Any suitable methods or systems can be utilized to ascertain whether a user leaves or arrives into the viewing area, examples of which are given below. If there are no changes to the user group, the method effectively branches back to step 1004. If, on the other hand, the user group changes, step 1008 determines whether any of the services that are being offered need to change. If none of the services that are being provided need to change, then the method effectively branches back to step 1004. If, on the other hand, one or more of the services that are being offered need to be changed, step 1010 changes one or more of the services and returns to step 1004 to provide the new mix of services.

Fingerprint Reader Panel

In accordance with one embodiment, a fingerprint reader panel can be utilized to ascertain when users enter and/or leave the viewing area associated with an EPG system.

For example, when a user enters the viewing area, they can touch their finger on the fingerprint reader. This can not only identify them as one of the previously-registered users, but can also provide the security necessary to avoid the possibility that someone else is claiming to be that user. Any suitable fingerprint reader can be utilized. A number of different fingerprint readers are available from companies such as DigitalPersona, Toshiba, Compaq and KeyTronic.

The fingerprint reader can be located at any suitable location associated with the viewing area. For example, the fingerprint reader can be located on a remote control. Alternately or additionally, the fingerprint reader can be positioned in a static location somewhere within the viewing area where users can gain convenient access. For example, the fingerprint reader can be located by a door into the viewing area, or can be incorporated into the television display itself. More than one fingerprint reader can be provided in the case where there are multiple doors into the viewing area. It may be preferable to place a fingerprint reader by each door into the viewing area. This can increase the chances that users entering and perhaps leaving the viewing area are adequately logged into and out of the EPG system.

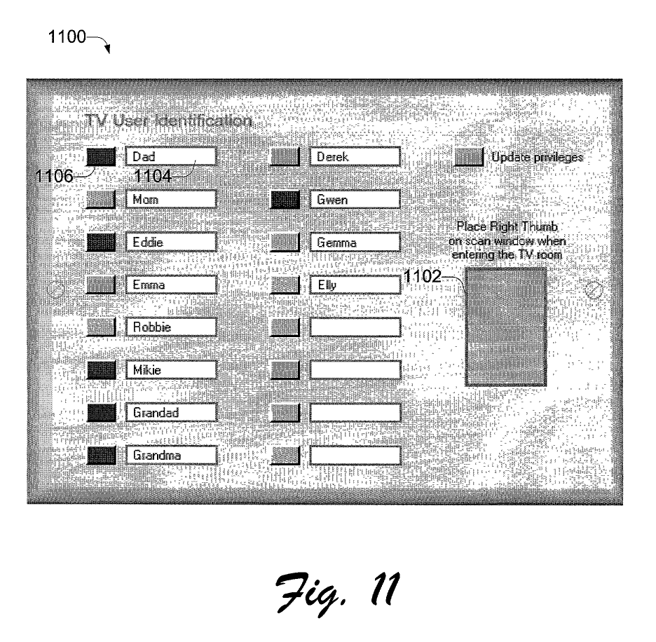

In connection with the fingerprint reader and the various other devices described herein, some type of indicator mechanism can be provided to visually indicate the users that the system believes are present. This provides a means by which the members of the current user group can be verified by members of the group. As but one example of a suitable indicator mechanism consider FIG. 11, which shows a display panel 1100 that includes a fingerprint scan window 1102 and multiple different user identification indicia for identifying users by name. As an example, the user identification indicia can include a field 1104 for identifying the user and an indicator 1106 that provides an indication of whether the system believes that the particular user is within the viewing area.

The user identification indicia can be provided as part of the graphical user interface screen or, as here, it can be incorporated as a component part of the fingerprint reader assembly. In this case, the indicators can be provided as an LED light or some other type of visual display.

In addition, the indicator mechanism can include a mechanism to allow a user to quickly indicate that they are or will shortly be leaving the viewing area. Any suitable mechanism can be used for this purpose. For example, a physical push button can be provided on display panel 1100 and can act as a switch to indicate that the user has left the room. In the FIG. 11 example, such a mechanism can be incorporated into indicator 1106 such that the indicator acts as not only a means by which a user's presence can be indicated, but also as a means by which each user can quickly log out of the system.

In this particular example, the indicator mechanism can be configured so that the only way for a user to turn on their associated light is to place their thumb on the fingerprint reader and be scanned into the system. The indicator mechanism can be configured, in this example, to enable any of the users to log any of the other users out by simply pressing the button associated with the user to be logged out. This can be useful for logging off a user who has to depart the room in a hurry. In the situation where a user has been registered during system setup as not requiring a secure login, then pressing the button for that user can be sufficient to indicate their presence. This can be useful for young children.

In the situation of a user who has been given administrative privileges when the system was set up (e.g. the father of the household), it can be advantageous to enable that user to log on other users, even when those other users' accounts have been set up to require secure login. This can be useful for indicating the presence of older children or grandparents. One mechanism for implementing this feature is for the administrative user to press a user button associated with the user they intend to log on, and then place their finger (i.e. the administrator's finger) on the fingerprint reader.

The display panel can also be used for incorporating other commonly-used system controls such as lighting controls, pause/play controls, on/off controls, volume control, favorite TV channel selector, favorite music selector and the like.

The EPG system can also use its knowledge of the particular users in the viewing area to perform other services. For example, when a user logs onto the system and the television is off, the system might turn the television on and tune it to the user's particular favorite channel. In the case where the television is already on and being watched by other users, then this action would not be performed.

Radio Smartcard Badges

In accordance with another embodiment, a radio smartcard badge can be utilized to ascertain when users enter and/or leave the viewing area associated with an EPG system.

Radio smartcard badges typically rely on radio wireless communication to enable the system to detect when users enter and leave the viewing area. Technologies such as Bluetooth can be utilized ensure that the transmission/receiving range of the system is about that which is typical of a viewing area, i.e. from about 10 to 20 feet. Radio smartcard badges can be implemented using any suitable technology. Exemplary devices can be obtained from companies such as Motorola.

Typically, when a user enters the viewing area, their presence is detected by the presence of a transmitting transmitter carried by their badge. When the user leaves the viewing area, the system can detect the loss of the user's signal and can ascertain that the user is no longer within the area.

Security can be provided by having the badge associated with a secure, unique identifier. This can easily be provided using a miniature smartcard inside the badge, e.g. a smartcard chip with a secure unique ID.

Although this embodiment has been discussed in the context of a smartcard badge, the radio smartcard can comprise any suitable wearable component that can be worn by and carried around by a user. Such components can include bracelets, anklets, and other items that can be worn by the user.

Radio smartcard badges (or other wearable components) have advantages and disadvantages over the fingerprint reader discussed above. For example, such wearable components are advantageous because the user need not do anything other than enter the viewing area to be identified by the system. Such components are typically very small so as not to encumber the user. However, in order to be accurately identified by the EPG system, the user should wear the component particularly when they intend to view programs within the viewing area. This can present a problem for forgetful users or users who are in a hurry and inadvertently forget to wear their component. Additionally, such smartcard components typically utilize a battery to power the transmitter. Accordingly, when the battery runs out of power, the user will have to change the battery.

Smartcard badges and other wearable components do, however, constitute a viable option for facilitating user identification within the viewing area.

Inductively Coupled Badges

In accordance with another embodiment, an inductively coupled badge can be utilized to ascertain when users enter and/or leave the viewing area associated with an EPG system.

Inductively coupled badges can avoid the battery issue associated with radio smartcard badges. Inductively coupled badges rely on an inductive coil being installed in the door way or at all the entry/exit points to the viewing area. As the badge passes through the doorway, an inductive loop in the badge is able to draw power via an inductive coupling and is therefore able to transmit its user's secure identification signal.

It can be desirable to have twin inductive loops in order to detect whether the user is entering or leaving the viewing area. Whether a user is entering or leaving is ascertained by determining which loop field is cut through first.

Providing inductive loops for all the entry/exit points for the viewing area can, however, be difficult to arrange in an open plan house. This can further be complicated by the need for twin loops to detect the direction of the user. Additionally, as with radio badges, inductively coupled badges need to be worn by the users when they intend to view programs offered by the EPG system.

Implementations using inductively-coupled badges can be facilitated by incorporating the badges into an ankle strap and by using inductive loops under any carpeting in the viewing area. Such badges may not be as easy to implement when there are hardwood floors rather than carpets in the viewing area.

Face Recognition

In accordance with another embodiment, face recognition techniques can be utilized to ascertain the identification of users within the viewing area associated with an EPG system.

Face recognition constitutes a viable way to identify users within the viewing area. As the technology of face recognition advances, its viability in this area will inevitably increase. Many technical papers and other documents have described face recognition techniques. A few of the papers are as follows: Akamatsu, et al., “An Accurate and Robust Face Identification Scheme,” IEEE, 217-220 (1992); Brunelli, et al., “Caricatural Effects in Automated Face Perception,” Biological Cybernetics, 69, 235-241 (1993); Chen, et al., “Human Face Recognition From a Single Front View,” International Journal of Pattern Recognition and Artificial Intelligence, 6 (4), 571-593 (1992); Chow, et al., “Towards a System for Automatic Facial Feature Detection,” Pattern Recognition, 26 (12), 1739-1755 (1993); Huang, et al., “Automatic Feature Point Extraction on a Human Face in Model-Based Image Coding,” Optical Engineering, 32 (7), 1571-1580 (1993); Huang, et al., “Human Facial Feature Extraction for Face Interpretation and Recognition,” IEEE, 204-207 (1992); Huang, et al, “Human Facial Feature Extraction for Face Interpretation and Recognition,” Pattern Recognition, 25 (12), 1435-1444 (1992); Kamel, et al., “System for the Recognition of Human Faces,” IBM Systems Journal, 32 (2), 307-320 (1993); Samal, et al., “Automatic Recognition and Analysis of Human Faces and Facial Expressions: A Survey,” Pattern Recognition, 25 (1), 65-77 (1992).

As such, face recognition techniques that are suitable for use in connection with this embodiment are known and, for the sake of brevity, are not described in any detail.

The task of face recognition in a viewing environment, such as the family television environment, is considerably simpler than in the context of other environments such as airports, shopping malls and other public areas. The reason for this is that in a viewing environment such as the family environment, there are typically a very small number of registered users that the system will attempt to identify. In other more public environments, there are typically a large number of individuals who need to be identified within a universe of individuals that potentially includes a very large number of individuals. In the EPG environment, one can allow much greater variation or freedom in the matching process. The degrees of freedom should, however, not be so lax as to permit spoofing.

It is desirable in many viewing environments, such as the home viewing environment, to implement a face recognition system that does not require users to position their face at a particular fixed location in order to have it recognized. This is not to say or imply that systems that require fixed locations are undesirable. Rather, it is more desirable to inconvenience the users as little as possible.

In accordance with one embodiment, one or more cameras can be employed to periodically monitor the entire viewing area. This can avoid not only the inconvenience that can be associated with using a fixed location for face recognition, but it can avoid the need for users to indicate when they have left the room. Advantageously, a capture camera can be sited at the television display and can identify users as they sit around the room.

Advantageously, face recognition can be performed by using a small number of still or static images, rather than using moving video images. This can reduce the processing complexities and costs associated with such a system. Using static images is also important because of the higher resolutions that can facilitate face recognition. That is, the effectiveness of systems that utilize face recognition can be enhanced by using high resolution images. Still cameras with high resolution capabilities (e.g. 4 MegaPixels and up) are typically fairly affordable. Such is not the case for high resolution video cameras.

In the case where a high resolution still camera is used to capture images of the viewing area, the first step that can be performed by the face recognition system is to identify, from the high resolution image of the viewing area, those image portions that constitute faces. The pixel areas of those image portions can then be cropped out and provided to a suitable face recognition algorithm. Different face recognition algorithms will be known and apparent to those of skill in the art. For the sake of brevity, such algorithms are not described in further detail herein.

The process of capturing a high resolution image of the viewing area can be repeated periodically, e.g. once per minute. This can serve two functions. First, from a security standpoint, it is desirable to have multiple shots of each face, each from a slightly different angle. This can help to guard against spoofing, e.g. kids trying to convince the EPG system that they are their father when all they are actually doing is holding up a photo of his face in front of their own. Second, it is desirable for the system to periodically capture and analyze the scene for purposes of ascertaining when a user has entered or left the room. This can be important so that the system can adjust viewing privileges and other services accordingly.

Voice Recognition

In accordance with another embodiment, voice recognition techniques can be utilized to ascertain the identification of users within the viewing area associated with an EPG system.

Voice recognition systems typically work best when the user is required to say a pre-determined phrase when entering or leaving the room. For example, upon entering the room, the user can say “Dad Entering” and, upon leaving the room, the user can say “Dad Leaving”. A microphone can be positioned, for example, in a panel or in the remote control. Security concerns are met, to some extent, by evaluating the unique voice print for that user which was previously learned by the system.

There are some concerns, however, associated with using voice recognition in viewing environments such as the home viewing environment. Such concerns include that the television environment is typically a noisy environment due to not only noise from the television audio, but noise associated with normal conversation that takes place between users. Additionally, some voice recognition systems may be easily spoofed by playing back a recording of another user. Further, each user will typically need to go to a specific place to use the microphone. Such systems can also be intrusive on the user from the standpoint of requiring the user to remember and say the appropriate words whenever they enter or leave the room.

Needless to say, however, in some scenarios and environments, voice recognition might be the appropriate choice for identifying users within the viewing area.

Individual Personal Computers

In accordance with another embodiment, an EPG system can be controlled and can receive input from one or more individual personal computers, such as laptop computers, tablet PCs and the like.

In accordance with this embodiment, rather than trying to identify the individual users on a single computer that is controlling the entertainment experience, each user has their own individual computer or computing device. Each individual computing device can execute an instance of the EPG software, including the guide and recommendation engine. In this scenario, the situation becomes one of arbitrating which user gets to control the main display over which the programs can be enjoyed by all. If a particular user is the primary user of the group of users, then their computing device can communicate with the main system and direct the system to present a particular program in accordance with the EPG system on their device. As each individual person has their own computing device, the issue of secure login is not as important because each person is presumed to have been securely logged into their own computing device.

System Behavior with Multiple Users

Once a particular user-identifying, EPG system is in place and the multiple users and rankings have been identified, the system can perform all of the functions that are intended for the user groups. Various functions are described in this document, as well as the documents that are incorporated by reference above.

Typically, a system using a metadata-matching recommendation engine, such as the one described above or one similar to it, will employ some means of matching user-specific attributes with program attributes for the purpose of making recommendations to the user as well as logging the user's history for future use. In the example described near the beginning of this document, such means comprises the User Preference File, which describes program attributes that the user likes, together with other personal preferences. When there are multiple users in the room, the situation is not as simple as recommending programs based on one individual's user preference file. Rather, in some scenarios, the preferences of the other users should, in some way, be taken into account.

As an example, consider the case of Censor Parental Ratings. A father's User Preference File may specify that he can watch content with all censor ratings. His kids' User Preference Files will typically specify that they can only watch “U” rated content. When the Father and the kids are in the room watching television together, the system should not show “R” rated content, even though the user Preference File for the primary user allows it.

To address these and other situations, a comprehensive rules module can be provided for the system to use. The rules module can define individual user collections and rules associated with the user collections. The rules can, among other things, circumscribe the types of programs that individual user collections can view.

Rules can be provided such that the system will look at all the User Preference Files for all of the current users, and determine whether particular types of programs can be shown. For example, one rule might specify that when the user collection consists of the primary user (Dad) and his kids, programs that are rated “PG” may be shown. Another rule might specify that when the user collection consists of “kids only”, then no “PG” or “R” rated movies may be shown. Thus, if Dad leaves the room, upon the transition in the user group, the system will not allow the kids to view “PG” or “R” rated programs.

In addition, in some embodiments, the EPG system can merge User Preference Files to provide a composite User Preference File to accommodate some user collections. This can be implemented by the system administrator specifying such a feature when the system is configured or when the configuration of the system is changed. For example, a rule might specify that when user A (e.g. Dad) and user B (e.g. Mom) are in the viewing area, then the system should use a User Preference File that comprises an intersection between the preferences in user A's file and the preferences in user B's file. In other situations, it may be appropriate to specify a rule that provides that when user A and user C are in the room, then only user A's User Preference File should be used. This approach can provide a great deal of control over how the EPG system is to function.

As but another approach, and one that constitutes a simpler solution to the issue of handling multiple users, consider the following. Individual users of the EPG system can have more than one User Preference File. Each of a particular user's files can be associated with a different persona for that user, and each can be given a convenient name of the user's choosing. As an example, consider the table that appears just below which characterizes different User Preference Files (UPFS) for the primary user Dad.

| User Preference File Name | Description |
|---|---|
| Dad_Mom | A UPF that stores program attributes that |
| | characterize the preferred content for |
| | viewing when watching programs with his |
| | wife. This is his default UPF. |
| Dad_Kids | A UPF that stores program attributes that |
| | characterize the preferred content for |
| | viewing when watching TV with his kids. |
| Dad_Alone | A UPF that stores program attributes |
| | associated with the type of content that |
| | he likes to watch when his wife and |
| | kids are out. |

Clearly, other personas or User Preference Files can be established to handle other user combinations that don't involve Dad. For example, Mom may have a User Preference file for herself, and one for when she watches programs with her kids. Additionally, the kids may have different personas or User Preference Files. For example, if two of the kids really enjoy the same types of programs, e.g. sports or arts and crafts, their user collection might have a User Preference File that specifies a preference for these types of shows. Yet, when one of the other kids joins the user collection, a different persona might define a set of preferences that incorporate the preference of the other kid.

The concept of personas or having different User Preference Files for a single user, can be used for other reasons as well. For example, personas can be used to provide for different user moods. For example, Dad might also have a persona called “Dad_Intellectual” which is a UPF that stores program attributes associated with the history and science documentaries that Dad may sometimes be interested in viewing when he is feeling particular intellectual. Similarly, if Dad is in the mood for a good laugh, he can have a persona called “Dad_Comedy” which is a UPF that stores attributes associated with comedy shows and movies that Dad may be interested in. Still further, a family persona might be defined for different family viewing moods. For example, a persona called “Family_Comedy” can comprise a UPF that stores attributes associated with family-rated comedies. Similarly, a persona called “Family_Adventure” can comprise a UPF that stores attributes associated with family-rated adventure programs or movies.

As can be seen, the use of multiple personas can be a very powerful tool for providing very precisely-defined types of programs for viewing. Some care, however, should be exercised when using multiple personas for reasons set forth below.

As soon as there is not a one-to-one correspondence between the login mechanism and the User Preference File or persona, further user action can be necessary. This can be handled by having one of the personas specified as the default for that user, and making the selection of alternate personas be something that the user specifically selects using an on-screen user interface once they have been logged on. It is also desirable to provide additional security around persona selection over and above what is provided by just being logged in. This can avoid others being able to look at your available personas while you are in the room but looking the other way. The user may even wish to hide even the very existence of some of their other personas.

For this reason a password mechanism can typically be used as part of the User Interface before the persona can be changed from the default for that user. This can constitute the same additional security mechanism that can be used before a user can view the contents of their User Preference File.

Additionally, with multiple personas, when a program attribute is added to a particular User Preference File, measures can be taken to ensure that the attribute is only added to the User Preference File that is currently in force. This means that, for example, a particular favorite actress that a user indicates as a preference will only be added to the UPF that the user is currently using. Program attributes can, however, be manually copied from one UPF to another, if so desired by a particular user.

Note also that some of the desired User Preference cases can be achieved very simply by just changing who is logged on. For example, if Dad is watching with his kids, he may choose not to log in, in which case, the system will recommend and show programs that are in accordance with just the kids' preferences. This concept can work well with in connection with the fingerprint reader embodiment, but can require additional user intervention in the case of the face recognition embodiment.

Exemplary Computer Environment

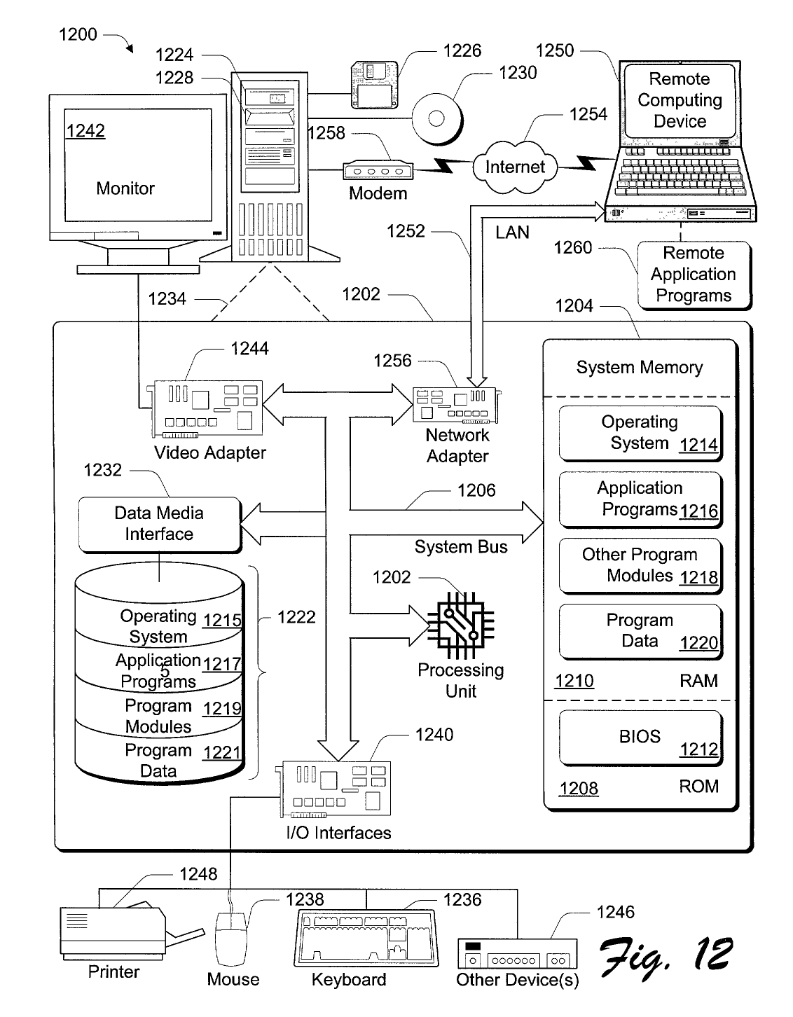

The various components and functionality described herein can be implemented with a number of individual computers that serve as client devices. FIG. 12 shows components of a typical example of such a computer generally at 1200. The components shown in FIG. 12 are only examples, and are not intended to suggest any limitations as to the scope of the claimed subject matter.

Generally, various different general purpose or special purpose computing system configurations can be used. Examples of well known computing systems, environments, and/or configurations that may be suitable for use in implementing the described embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Various functionalities of the different computers can be embodied, in many cases, by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 12, the components of computer 1200 may include, but are not limited to, a processing unit 1202, a system memory 1204, and a system bus 1206 that couples various system components including the system memory to the processing unit 1202. The system bus 1206 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 1200 typically includes a variety of computer-readable media. Computer-readable media can be any available media that can be accessed by computer 1200 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1200. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1204 includes computer storage media in the form of volatile and/or nonvolatile memory such as read only memory (ROM) 1208 and random access memory (RAM) 1210. A basic input/output system 1212 (BIOS), containing the basic routines that help to transfer information between elements within computer 1200, such as during start-up, is typically stored in ROM 1208. RAM 1210 typically contains data and/or program modules that are immediately accessible to and/or presently being operated on by processing unit 1202. By way of example, and not limitation, FIG. 12 illustrates operating system 1214, application programs 1216, other program modules 1218, and program data 1220.

The computer 1200 may also include other removable/non-removable, volatile/nonvolatile computer storage media. By way of example only, FIG. 12 illustrates a hard disk drive 1222 that reads from or writes to non-removable, nonvolatile magnetic media, a magnetic disk drive 1224 that reads from or writes to a removable, nonvolatile magnetic disk 1226, and an optical disk drive 1228 that reads from or writes to a removable, nonvolatile optical disk 1230 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1222 is typically connected to the system bus 1206 through a non-removable memory interface such as data media interface 1232, and magnetic disk drive 1224 and optical disk drive 1228 are typically connected to the system bus 1206 by a removable memory interface such as interface 1234.

The drives and their associated computer storage media discussed above and illustrated in FIG. 12 provide storage of computer-readable instructions, data structures, program modules, and other data for computer 1200. In FIG. 12, for example, hard disk drive 1222 is illustrated as storing operating system 1215, application programs 1217, other program modules 1219, and program data 1221. Note that these components can either be the same as or different from operating system 1214, application programs 1216, other program modules 1218, and program data 1220. Operating system 1215, application programs 1217, other program modules 1219, and program data 1221 are given different numbers here to illustrate that, at a minimum, they are different copies. A user may enter commands and information into the computer 1200 through input devices such as a keyboard 1236 and pointing device 1238, commonly referred to as a mouse, trackball, or touch pad. Other input devices (not shown) may include a microphone, joystick, game pad, satellite dish, scanner, or the like. These and other input devices are often connected to the processing unit 1202 through an input/output (I/O) interface 1240 that is coupled to the system bus, but may be connected by other interface and bus structures, such as a parallel port, game port, or a universal serial bus (USB). A monitor 1242 or other type of display device is also connected to the system bus 1206 via an interface, such as a video adapter 1244. In addition to the monitor 1242, computers may also include other peripheral output devices 1246 (e.g., speakers) and one or more printers 1248, which may be connected through the I/O interface 1240.

The computer may operate in a networked environment using logical connections to one or more remote computers, such as a remote computing device 1250. The remote computing device 1250 may be a personal computer, a server, a router, a network PC, a peer device or other common network node, and typically includes many or all of the elements described above relative to computer 1200. The logical connections depicted in FIG. 12 include a local area network (LAN) 1252 and a wide area network (WAN) 1254. Although the WAN 1254 shown in FIG. 12 is the Internet, the WAN 1254 may also include other networks. Such networking environments are commonplace in offices, enterprise-wide computer networks, intranets, and the like.

When used in a LAN networking environment, the computer 1200 is connected to the LAN 1252 through a network interface or adapter 1256. When used in a WAN networking environment, the computer 1200 typically includes a modem 1258 or other means for establishing communications over the Internet 1254. The modem 1258, which may be internal or external, may be connected to the system bus 1206 via the I/O interface 1240, or other appropriate mechanism. In a networked environment, program modules depicted relative to the computer 1200, or portions thereof, may be stored in the remote computing device 1250. By way of example, and not limitation, FIG. 12 illustrates remote application programs 1260 as residing on remote computing device 1250. It will be appreciated that the network connections shown are exemplary and other means of establishing a communications link between the computers may be used.

Conclusion

The various embodiments described above can greatly facilitate the manner in which an EPG system can offer services to multiple users. The services can be very specifically tailored to individual users or groups of users.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method comprising:
registering multiple users with a client device having an electronic program guide system thereon; and
establishing a ranking of the multiple users, the electronic program guide system being configured to use the ranking as a reference for providing services to collections of users.

2. The method of claim 1, wherein the act of establishing comprises establishing a primary user and one or more secondary users.

3. The method of claim 1, wherein the act of establishing comprises establishing a primary user and one or more secondary users, the secondary users being ranked.

4. The method of claim 1, wherein the services that can be provided by the electronic program guide system comprise one or more of the following: a program recommendation service, a guidance service that defines which types of programs can be viewed, a security service, and a program presentation service.

5. The method of claim 1, wherein the services that can be provided by the electronic program guide system comprise at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

6. The method of claim 5, wherein the electronic program guide system is further configured to make program recommendations by computing scores for individual matches that it ascertains.

7. One or more computer-readable media having computer-readable instructions thereon which, when executed by one or more processors, cause the one or more processors to implement the method of claim 1.

8. A system comprising:
one or more computer-readable media;
one or more processors;
computer-readable instructions on the one or more computer-readable media which, when executed by the one or more processors, cause the one or more processors to:
register multiple users with an electronic program guide system; and
establish a ranking of the multiple users, the electronic program guide system being configured to use the ranking as a reference for providing services to collections of users..

9. The system of claim 8, wherein the services that can be provided by the electronic program guide system comprise one or more of the following: a program recommendation service, a guidance service that defines which types of programs can be viewed, a security service, and a program presentation service.

10. The system of claim 8, wherein the services that can be provided by the electronic program guide system comprise at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

11. A method comprising:
registering multiple users with a client device having an electronic program guide system thereon;
establishing a ranking of the multiple users, the electronic program guide system being configured to use the ranking as a reference for providing services to collections of users;
ascertaining one or more users within a viewing area associated with the client device; and
providing one or more services via the electronic program guide system based on which users are ascertained to be in the viewing area.

12. The method of claim 11, wherein the act of establishing comprises establishing a primary user and one or more secondary users.

13. The method of claim 11, wherein the act of establishing comprises establishing a primary user and one or more secondary users, the secondary users being ranked.

14. The method of claim 11, wherein the act of providing comprises providing one or more of the following services: a program recommendation service, a guidance service that defines which types of programs can be viewed, a security service, and a program presentation service.

15. The method of claim 11, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

16. The method of claim 15, wherein the electronic program guide system is further configured to make program recommendations by computing scores for individual matches that it ascertains.

17. One or more computer-readable media having computer-readable instructions thereon which, when executed by one or more processors, cause the one or more processors to implement the method of claim 11.

18. One or more client devices embodying the one or more computer-readable media of claim 17.

19. A method comprising:
registering multiple users with a client device having an electronic program guide system thereon;
establishing a ranking of the multiple users, the electronic program guide system being configured to use the ranking as a reference for providing services to collections of users;
ascertaining one or more users within a viewing area associated with the client device; and
providing one or more services via the electronic program guide system as a function of the highest ranking user in the viewing area.

20. The method of claim 19, wherein the act of providing comprises providing one or more of the following services: a program recommendation service, a guidance service that defines which types of programs can be viewed, a security service, and a program presentation service.

21. The method of claim 19, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

22. The method of claim 19, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs, the electronic program guide system further being configured to make program recommendations by computing scores for individual matches that it ascertains.

23. One or more computer-readable media having computer-readable instructions thereon which, when executed by one or more processors, cause the one or more processors to implement the method of claim 19.

24. A system comprising:
one or more computer-readable media;
one or more processors; and
computer-readable instructions on the one or more computer-readable media which, when executed by the one or more processors, cause the one or more processors to:
register multiple users with an electronic program guide system thereon;
establish a ranking of the multiple users, the electronic program guide system being configured to use the ranking as a reference for providing services to collections of users;
ascertain one or more users within a viewing area associated with the electronic program guide system; and
provide one or more services via the electronic program guide system as a function of the highest ranking user in the viewing area.

25. The system of claim 24, wherein the services that are provided via the electronic program guide system comprise one or more of the following services: a program recommendation service, a guidance service that defines which types of programs can be viewed, a security service, and a program presentation service.

26. A method comprising:
ascertaining a collection of users within a viewing area associated with an electronic program guide system;
providing one or more services, via the electronic program guide system, as a function of the user collection;
determining whether a constituency of the user collection changes;
if the constituency of the user collection changes, determining whether any of the services that are being provided need to change as a result of the constituency changing; and
changing one or more of the services if, as a result of the constituency change, one or more of the services need to be changed.

27. The method of claim 26, wherein the user collection can be defined in terms of a persona that includes more than one user.

28. The method of claim 26, wherein the services comprise one or more of the following: a program viewing service that defines which programs can be viewed by which user collections and a program recommendation service that recommends programs to the user collections.

29. The method of claim 26, wherein the act of changing the one or more services takes place immediately after the constituency change is determined.

30. The method of claim 26, wherein the act of changing the one or more services takes place responsive to a next user action with respect to the electronic program guide system.

31. The method of claim 26, wherein the act of determining whether the constituency of the user collection changes is performed by receiving direct user input that indicates a change.

32. The method of claim 26, wherein the act of determining whether the constituency of the user collection changes is performed by the electronic program system automatically detecting a change without any action on the part of a user other than entering or leaving the viewing area.

33. One or more computer-readable media having computer-readable instructions thereon which, when executed by one or more processors, cause the one or more processors to implement the method of claim 26.

34. A system comprising:
one or more computer-readable media;
one or more processors; and
computer-readable instructions on the one or more computer-readable media which, when executed by the one or more processors, cause the one or more processors to:
ascertain a collection of users within a viewing area associated with an electronic program guide system;
provide one or more services, via the electronic program guide system, as a function of the user collection;
determine whether a constituency of the user collection changes;
if the constituency of the user collection changes, determine whether any of the services that are being provided need to change as a result of the constituency changing; and
change one or more of the services if, as a result of the constituency change, one or more of the services need to be changed.

35. The system of claim 34, wherein the user collection can be defined in terms of a persona that includes more than one user.

36. The system of claim 34, wherein the services comprise one or more of the following: a program viewing service that defines which programs can be viewed by which user collections and a program recommendation service that recommends programs to the user collections.

37. The system of claim 34, wherein the services can be changed immediately after the constituency change is determined.

38. The system of claim 34, wherein the services can be changed responsive to a next user action with respect to the electronic program guide system.

39. The system of claim 34, wherein the instructions cause the one or more processors to determine whether the constituency of the user collection changes by receiving direct user input that indicates a change.

40. The system of claim 34, wherein the instructions cause the one or more processors to determine whether the constituency of the user collection changes by automatically detecting a change without any action on the part of a user other than entering or leaving the viewing area.

41. A method comprising:
ascertaining, via one or more devices associated with a viewing system on which programs can be viewed, a collection of users within a viewing area associated with the viewing system; and
providing one or more services via the viewing system based on the collection of users in the viewing area.

42. The method of claim 41, wherein the act of providing comprises providing one or more of the following services: a program recommendation service, a guidance service that defines which types of programs can be viewed, a security service, and a program presentation service.

43. The method of claim 41, wherein said one or more devices comprise at least one device that is worn by a user.

44. The method of claim 41, wherein said one or more devices comprise at least one device that is worn by a user and configured for wireless communication.

45. The method of claim 41, wherein said one or more devices comprise at least one device that is worn by a user in the form of a radio smartcard badge.

46. The method of claim 41, wherein said one or more devices comprise at least one inductively coupled device that is worn by a user.

47. The method of claim 41, wherein said one or more devices comprise at least one device that is not worn by a user.

48. The method of claim 47, wherein the one or more devices comprise is computing devices.

49. The method of claim 47, wherein the one or more devices comprise personal computing devices.

50. The method of claim 47, wherein the one or more devices comprise a voice recognition device.

51. The method of claim 41, wherein the act of providing comprises providing at least a program recommendation service that is implemented, at least in part, via one or more user preference files associated with each of the multiple users, the viewing system being configured to make program recommendations by, at least in part, ascertaining matches between user-specified attributes in the various user preference files and program attributes associated with individual programs.

52. The method of claim 41, wherein the act of providing comprises providing at least a program recommendation service that is implemented, at least in part, via one or more user preference files associated with each of the multiple users, the viewing system being configured to make program recommendations by, at least in part, ascertaining matches between user-specified attributes in the various user preference files and program attributes associated with individual programs, the electronic program guide system being further configured to make program recommendations by computing scores for individual matches that it ascertains.

53. The method of claim 41 further comprising ascertaining whether the constituency of the user collection changes and if so, whether one or more services need to be changed.

54. One or more computer-readable media having computer-readable instructions thereon which, when executed by one or more processors, cause the one or more processors to implement the method of claim 41.

55. A system comprising:
one or more computer-readable media having computer-readable instructions thereon which, when executed by one or more processors, cause the one or more processors to implement the method of claim 41; and
one or more client devices embodying the one or more computer-readable media.

56. A system comprising:
a viewing system configured to provide program services to users;
one or more devices associated with the viewing system and configured to enable users within a viewing area of the viewing system to be identified to the viewing system; and
the viewing system being configured to provide one or more services based on a collection of users that are identified to be in the viewing area.

57. The system of claim 56, wherein the viewing system is configured to provide one or more of the following services: a program recommendation service, a guidance service that defines which types of programs can be viewed, a security service, and a program presentation service.

58. The system of claim 56, wherein said one or more devices comprise at least one device that can be worn by a user.

59. The system of claim 56, wherein said one or more devices comprise at least one device that can be worn by a user in the form of a device configured for wireless communication.

60. The system of claim 56, wherein said one or more devices comprise at least one device that can be worn by a user in the form of a radio smartcard badge.

61. The system of claim 56, wherein said one or more devices comprise at least one inductively coupled device that can be worn by a user.

62. The system of claim 56, wherein said one or more devices comprise at least one device that is not worn by a user.

63. The system of claim 62, wherein the one or more devices comprise computing devices.

64. The system of claim 62, wherein the one or more devices comprise personal computing devices.

65. The system of claim 62, wherein the one or more devices comprise a fingerprint reader device.

66. The system of claim 62, wherein the one or more devices comprise a face recognition device.

67. A method comprising:
ascertaining, via a user-engagable, fingerprint reader device, a collection of users within a viewing area associated with a device embodying an electronic program guide system; and
providing one or more services via the electronic program guide system based on the collection of users in the viewing area.

68. The method of claim 67, wherein the act of providing comprises providing one or more of the following services: a program recommendation service, a guidance service that defines which types of programs can be viewed, a security service, and a program presentation service.

69. The method of claim 67, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

70. The method of claim 67, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs, the electronic program guide system being further configured to make program recommendations by computing scores for individual matches that it ascertains.

71. The method of claim 67 further comprising ascertaining whether the constituency of the user collection changes and if so, whether one or more services need to be changed.

72. The method of claim 71, wherein ascertaining a change in the user collection constituency is performed via the user-engagable fingerprint reader device.

73. The method of claim 71, wherein ascertaining a change in the user collection constituency is not performed via the user-engagable fingerprint reader device.

74. The method of claim 71 further comprising changing one more services as a result of a change in the user collection constituency.

75. One or more computer-readable media having computer-readable instructions thereon which, when executed by one or more processors, cause the one or more processors to implement the method of claim 67.

76. A method comprising:
ascertaining a collection of users within a viewing area associated with a device embodying the electronic program guide system;
providing one or more services via the electronic program guide system based on the collection of users in the viewing area; and
visually indicating a collection of users that the electronic program guide system believes are in the viewing area.

77. The method of claim 76, wherein the act of visually indicating is performed using a display panel having user identification indicia for identifying various users.

78. The method of claim 76, wherein the act of visually indicating is performed using a graphical user interface screen.

79. The method of claim 76, wherein the act of visually indicating is performed using a mechanism that includes a means for allowing a user to indicate that they are or will be leaving the viewing area.

80. One or more computer-readable media having computer-readable instructions thereon which, when executed by one or more processors, cause the one or more processors to implement the method of claim 76.

81. A system comprising:
one or more computer-readable media having computer-readable instructions thereon which, when executed by one or more processors, cause the one or more processors to implement the method of claim 76; one or more client devices embodying the one or more computer-readable media.

82. A method comprising:
ascertaining, via face recognition techniques, a collection of users within a viewing area associated with a device embodying an electronic program guide system; and
providing one or more services via the electronic program guide system based on the collection of users in the viewing area.

83. The method of claim 82, wherein the act of providing comprises providing one or more of the following services: a program recommendation service, a guidance service that defines which types of programs can be viewed, a security service, and a program presentation service.

84. The method of claim 82, wherein the act of providing comprises providing at least a program recommendation service that is implemented, at least in part, via one or more user preference files associated with each of the multiple users, the electronic program guide system being configured to make program recommendations by, at least in part, ascertaining matches between user-specified attributes in the various user preference files and program attributes associated with individual programs.

85. The method of claim 84, wherein the electronic program guide system is further configured to make program recommendations by computing scores for individual matches that it ascertains.

86. The method of claim 82 further comprising ascertaining, via the face recognition techniques, whether the constituency of the user collection changes and if so, whether one or more services need to be changed.

87. The method of claim 86 further comprising changing one or more services as a result of a change in the user collection constituency.

88. One or more computer-readable media having computer-readable instructions thereon which, when executed by one or more processors, cause the one or more processors to implement the method of claim 82.

89. A method comprising:
capturing one or more images of a viewing area associated with an electronic program guide system;
identifying, from the one or more images, image portions that constitute a face;
processing at least the image portions to identify one or more users within the viewing area; and
providing one or more services via the electronic program guide system as a function of the collection of users that are identified within the viewing area.

90. The method of claim 89, wherein the acts of capturing, identifying, processing, and providing are performed periodically.

91. The method of claim 89 further comprising if a collection of users within the viewing area changes, determining whether any of the services that are being provided need to be changed and if so, changing one or more of the services.

92. One or more computer-readable media having computer-readable instructions thereon which, when executed by one or more processors, cause the one or more processors to implement the method of claim 89.

93. A system comprising:
one or more computer-readable media having computer-readable instructions thereon which, when executed by one or more processors, cause the one or more processors to implement the method of claim 89; and
one or more devices embodying the one or more computer-readable media.

94. A method comprising:
providing one or more rules associated with different collections of users of an electronic program guide system;
identifying users within a viewing area associated with the electronic program guide system;
selecting one or more rules based on the collection of identified users; and
using the selected rules to control the electronic program guide system.

95. The method of claim 94, wherein the act of using the rules comprises selecting program types for viewing.

96. The method of claim 94, wherein the act of using the rules comprises recommending program types for viewing.

97. The method of claim 94, wherein the act of using the rules comprises evaluating one or more user preference files associated with the collection of identified users, the user preference files defining preferences associated with individual users.

98. The method of claim 94, wherein the act of using the rules comprises using the rules to select one or more services to provide to the collection of identified users.

99. The method of claim 94, wherein the act of using the rules comprises merging at least portions of user preference files associated with two or more users, the user preference files defining preferences associated with individual users.

100. One or more computer-readable media having computer-readable instructions thereon which, when executed by one or more processors, cause the one or more processors to implement the method of claim 94.

101. A system comprising:
one or more computer-readable media having computer-readable instructions thereon which, when executed by one or more processors, cause the one or more processors to implement the method of claim 94; and
one or more client devices embodying the one or more computer-readable media.

102. A method comprising:
associating multiple users of an electronic program guide system using one or more personas, a persona defining preferences associated with the multiple users;
identifying users within a viewing area associated with the electronic program guide system; and
providing one or more services via the electronic program guide system based on a persona that represents the users within the viewing area.

103. The method of claim 102, wherein individual personas are embodied as a user preference file that is maintained by the electronic program guide system.

104. The method of claim 102 further comprising associating with an individual user, a user preference file associated with that user, and at least one user preference file associated with a persona of that user, the user preference files defining viewing preferences for the user and their persona.

105. The method of claim 104, wherein the user preference file that is associated with a persona of the user is also associated with at least one other user.

106. One or more computer-readable media having computer-readable instructions thereon which, when executed by one or more processors, cause the one or more processors to implement the method of claim 102.

107. A system comprising:
one or more computer-readable media having computer-readable instructions thereon which, when executed by one or more processors, cause the one or more processors to implement the method of claim 102; and
one or more client devices embodying the one or more computer-readable media.

108. A method comprising:
associating multiple personas with a single user of an electronic program guide system, the personas defining preferences associated with the user; and
providing one or more services via the electronic program guide system based on a persona that represents the user.

109. The method of claim 108, wherein the personas are embodied as user preference files that are maintained by the electronic program guide system.

110. The method of claim 108, wherein at least one persona includes other users.

111. The method of claim 108, wherein at least one persona does not include other users.

112. The method of claim 108, wherein at least one persona is associated with a user's mood.

113. The method of claim 108 further comprising specifying one persona as a default persona.

114. The method of claim 108 further comprising protecting one or more of the personas with a password.

115. One or more computer-readable media having computer-readable instructions thereon which, when executed by one or more processors, cause the one or more processors to implement the method of claim 108.

116. A system comprising:
one or more computer-readable media having computer-readable instructions thereon which, when executed by one or more processors, cause the one or more processors to implement the method of claim 108; and
one or more client devices embodying the one or more computer-readable media.
